(19) United States
(12) Patent Application Publication
(10) Pub. No.: US 2026/0223897 A1
(43) Pub. Date: Aug. 6, 2026

(54) SIAMENOSIDE I SWEETENED BEVERAGES WITH MOGROSIDE BLENDS

(71) Applicant: The Coca-Cola Company, Atlanta, GA (US)

(72) Inventors: Indra Prakash, Atlanta, GA (US); Gil Ma, Atlanta, GA (US); Christopher Mercogliano, Atlanta, GA (US); Juvenal Higiro, Atlanta, GA (US); Iris Liaw Jung, Atlanta, GA (US); Michelle Heatherly Heath, Atlanta, GA (US); Allison Bechman, Atlanta, GA (US)

(21) Appl. No.: 19/149,781

(22) PCT Filed: Jan. 30, 2024
(86) PCT No.: PCT/US2024/013536

§ 371 Date: Jul. 21, 2025

Related U.S. Application Data
(60) Provisional application No. 63/482,263, filed on Jan. 30, 2023.

(51) Int. Cl. A23L 2/60; A23L 2/385; A23L 2/54; A23L 27/00; A23L 27/30; C12G 3/06

(52) U.S. Cl. CPC A23L 2/60; A23L 2/385; A23L 2/54; A23L 27/36; A23L 27/86; C12G 3/06

(57) ABSTRACT

Diet beverages sweetened with a mogroside blend sweetener comprising siamenoside I with improved sensory attributes are described. Isomogroside V, 11-oxomogroside V, mogroside III, mogroside IIE, mogroside V and mogroside IIIE, when blended with siamenoside I in certain ratios, can be used to reduce bitterness, sweetness linger, bitter linger, metallic taste, and/or astringency, when used to sweeten beverages compared to siamenoside I only sweetened beverages.

### CROSS-REFERENCE TO RELATED APPLICATION

This application claims priority to U.S. Provisional Application No. 63/482,263, filed Jan. 30, 2023, which is incorporated herein in its entirety.

### FIELD OF THE INVENTION

The present invention relates generally to diet beverages containing mogroside blend sweeteners comprising siamenoside I.

### BACKGROUND OF THE INVENTION

Natural caloric sugars, such as sucrose, fructose and glucose, are used to provide a pleasant taste to beverages. Sucrose imparts a taste preferred by consumers. Although sucrose provides superior sweetness characteristics, it is disadvantageously caloric.

Increasingly, non-caloric or low caloric sweeteners have been introduced to satisfy consumer demand. However, non- and low-caloric sweeteners differ from natural caloric sugars in ways that frustrate consumers. On a taste basis, high potency sweeteners exhibit temporal profiles, maximal responses, flavor profiles, mouth feels, and/or adaptation behavior that differs from sugar. High potency sweeteners often exhibit delayed sweetness onset, lingering sweet aftertaste, bitter taste, metallic taste, astringent taste, cooling taste and/or licorice-like taste.

The fruit extract of Siraitia grosvenori (monk fruit, Luo Han Guo) has been used as a traditional medicine in China for centuries. It has been approved as a sweetener in Asian countries, the United States (GRAS approved), Canada, Australia, and New Zealand.

Mogrosides, cucurbitane-type triterpene glycosides isolated from S. grosvenorii, are principle sweet components of the fruit. More than 60 mogrosides have been identified. Several well-studied mogrosides display a marked difference in sweetness intensity and taste profile. Mogrosides I and II have similar sweetness level as sucrose, while mogrosides IV, V, and siamenoside I are measured 233 to 392, 250 to 425, and 465 to 563 times sweeter than sucrose at various concentration levels, respectively.

Siamenoside I presents a better balance in sweetness, bitterness, sweet linger, astringency, and mouthfeel than mogroside V (WO 2018213683 A1). However, use of high purity siamenoside I at high concentrations, e.g., concentrations required to achieve a sucrose equivalence to 10° Brix (typical of sweetened carbonated beverages), elicits different sensory properties including significant off-tastes such as licorice, metallic and bitter tastes, as well as sweetness lingering and bitter lingering, as well as sensations of astringency or other features.

Accordingly, there remains a need for siamenoside I-based sweeteners that have improved taste and flavor profiles.

### SUMMARY OF THE INVENTION

The present invention relates to diet beverages sweetened with a mogroside blend containing primarily siamenoside I with improved taste properties.

In one aspect, a diet beverage comprises a mogroside blend in a sweetening amount, wherein the mogroside blend comprises at least about 70% siamenoside I by weight on a dry basis and at least one of the following:
a. from 0.01% to about 25% isomogroside V by weight on a dry basis;
b. from about 0.01% to about 25% 11-oxomogroside V by weight on a dry basis;
c. from about 0.01% to about 5% 11-oxomogroside III by weight on a dry basis;
d. from about 0.01% to about 5% mogroside III by weight on a dry basis;
e. from about 0.01% to about 5% 11-oxoisomogroside V by weight on a dry basis;
f. from about 0.01% to about 5% mogroside IIE by weight on a dry basis;
g. from about 0.01% to about 10% mogroside IVA by weight on a dry basis;
h. from about 0.01% to about 20% mogroside IIIA2 by weight on a dry basis;
i. from about 0.01% to about 20% mogroside IIA by weight on a dry basis;
j. from about 0.01% to about 5% mogroside IIA1 by weight on a dry basis;
k. from about 0.01% to about 1% mogroside IA by weight on a dry basis;
l. from about 0.01% to about 1% mogroside IE by weight on a dry basis;
m. from about 0.01% to about 1% oxomogroside IIA1 by weight on a dry basis;
n. from about 0.01% to about 1% oxomogroside IIA2 by weight on a dry basis;
o. from about 0.01% to about 2.5% 11-oxomogroside IIA by weight on a dry basis;
p. from about 0.01% to about 20% 11-oxomogroside IIE by weight on a dry basis;
q. from about 0.01% to about 30% mogroside V by weight on a dry basis;
r. from about 0.01% to about 20% mogroside IIIE by weight on a dry basis;
s. from about 0.01% to about 20% 11-oxosiamenoside I by weight on a dry basis; and/or
t. from about 0.01% to about 20% 11-oxomogroside IIIE by weight on a dry basis.

It has been found that the claimed mogroside blend sweeteners have improved sensory properties compared to mogrosides blends sweetened with siamenoside I only. In particular, diet beverages sweetened with the mogroside blends of the present invention have less bitterness, less sweetness linger, less bitter linger, less metallic taste, and/or less astringency. In addition, the diet beverages provided herein have improved sweetness onset, and mouthfeel.

### DETAILED DESCRIPTION OF THE INVENTION

### I. Definitions

“Beverage”, as used herein, refers to liquids suitable for human consumption.

“Diet beverage,” as used herein, refers to reduced-calorie beverages including mid-calorie beverages, low-calorie beverages, and zero-calorie beverages. Some diet beverages may contain sucrose, but in a quantity less than a full-calorie beverage. Diet beverages herein comprise at least one non-sucrose sweetener, e.g., a high potency sweetener.

“Reduced calorie,” as used herein, refers to a beverage comprising a mixture of caloric sweeteners (e.g., sucrose) and one or more non-sucrose sweeteners. Reduced-calorie beverages include mid-calorie beverages and low-calorie beverages.

“Mid-calorie beverage,” as used herein, refers to a beverage that has from 41 to 60 calories per 8 oz. serving.

“Low-calorie beverage,” as used herein, refers to a beverage that has from 6 to 40 calories per 8 oz. serving.

“Zero-calorie beverage,” as used herein, refers to a beverage that has less than 5 calories per 8 oz. serving.

“Natural high potency sweetener” or “NHPS” as used herein, refers to any sweetener found naturally in nature and characteristically has a sweetness potency greater than sucrose, fructose, or glucose, yet has less calories. The natural high potency sweetener can be provided as a pure compound or, alternatively, as part of an extract.

“Synthetic high potency sweetener,” as used herein, refers to any composition which is not found naturally in nature and characteristically has a sweetness potency greater than sucrose, fructose, or glucose, yet has less calories.

“Total mogroside content”, as used herein, refers to the sum of the relative weight contributions of each mogroside in a sample.

### II. Beverages and Beverage Products

In one aspect, a diet beverage comprising a mogroside blend sweetener comprising siamenoside I as the major component is provided.

The mogroside blend is comprised of mogrosides, i.e., assumes 100% total mogroside content.

The mogroside blend comprises at least about 70% siamenoside I by weight on a dry basis, such as, for example, at least about 75%, at least about 80%, at least about 85%, at least about 90%, at least about 95%, or at least about 97%. In a particular embodiment, the mogroside blend comprises at least about 80% siamenoside I by weight on a dry basis. In certain embodiments, the mogroside blend comprises from about 4:1 to about 99:1 siamenoside I:other mogrosides.

It has been found that isomogroside V, 11-oxomogroside V, 11-oxomogroside III, mogroside III, 11-oxoisomogroside V, and mogroside IIE, when blended with siamenoside I in certain ratios, provide less objectionable taste attributes (e.g., less bitterness, sweetness linger, bitter linter, metallic taste, and/or astringency) when used to sweeten beverages compared to siamenoside I only sweetened beverages. In certain embodiments, the mogroside blends comprises siamenoside I and one or more of isomogroside V, 11-oxomogroside V, 11-oxomogroside III, mogroside III, 11-oxoisomogroside V, and mogroside IIE.

In some embodiments, the mogroside blend comprises isomogroside V in an amount from about 0.01% to about 25% by weight on a dry basis, such as, for example, from about 1% to about 25% by weight on a dry basis, from about 1% to about 20% by weight on a dry basis, from about 1% to about 15% by weight on a dry basis, from about 1% to about 10% by weight on a dry basis, from about 1% to about 5% by weight on a dry basis, from about 5% to about 25% by weight on a dry basis, from about 5% to about 20% by weight on a dry basis, from about 5% to about 15% by weight on a dry basis, from about 5% to about 10% by weight on a dry basis, from about 10% to about 25% by weight on a dry basis, from about 10% to about 20% by weight on a dry basis, from about 10% to about 15% by weight on a dry basis, from about 15% to about 25% by weight on a dry basis, from about 15% to about 20% by weight on a dry basis, or from about 20% to about 25% by weight on a dry basis.

In some embodiments, the mogroside blend comprises 11-oxomogroside V in an amount from about 0.01% to about 25% by weight on a dry basis, such as, for example, from about 1% to about 20% by weight on a dry basis, from about 1% to about 15% by weight on a dry basis, from about 1% to about 10% by weight on a dry basis, from about 1% to about 5% by weight on a dry basis, from about 5% to about 25% by weight on a dry basis, from about 5% to about 20% by weight on a dry basis, from about 5% to about 15% by weight on a dry basis, from about 5% to about 10% by weight on a dry basis, from about 10% to about 25% by weight on a dry basis, from about 10% to about 20% by weight on a dry basis, from about 10% to about 15% by weight on a dry basis, from about 15% to about 25% by weight on a dry basis, from about 15% to about 20% by weight on a dry basis, or from about 20% to about 25% by weight on a dry basis.

In some embodiments, the mogroside blend comprises 11-oxomogroside III in an amount from about 0.01% to about 5% by weight on a dry basis, such as, for example, from about 1% to about 5% by weight on a dry basis, from about 1% to about 2.5% by weight on a dry basis, or about 2.5% to about 5% by weight on a dry basis.

In some embodiments, the mogroside blend comprises mogroside III in an amount from about 0.01% to about 5% by weight on a dry basis, such as, for example, from about 1% to about 5% by weight on a dry basis, from about 1% to about 2.5% by weight on a dry basis, or about 2.5% to about 5% by weight on a dry basis.

In some embodiments, the mogroside blend comprises 11-oxoisomogroside V in an amount from about 0.01% to about 5% by weight on a dry basis, such as, for example, from about 1% to about 5% by weight on a dry basis, from about 1% to about 2.5% by weight on a dry basis, or about 2.5% to about 5% by weight on a dry basis.

In some embodiments, the mogroside blend comprises mogroside IIE in an amount from about 0.01% to about 5% by weight on a dry basis, such as, for example, from about 1% to about 5% by weight on a dry basis, from about 1% to about 2.5% by weight on a dry basis or about 2.5% to about 5% by weight on a dry basis.

In certain embodiments, the mogroside blends comprise siamenoside I and one or more of: isomogroside V, 11-oxomogroside V, mogroside III, mogroside IIE, mogroside V and mogroside IIIE.

In one embodiment, a diet beverage comprises a mogroside blend in a sweetening amount, wherein the mogroside blend comprises at least about 70% siamenoside I by weight on a dry basis and at least one of the following:
a. from 0.01% to about 25% isomogroside V by weight on a dry basis;
b. from about 0.01% to about 25% 11-oxomogroside V by weight on a dry basis;
c. from about 0.01% to about 5% mogroside III by weight on a dry basis;
d. from about 0.01% to about 5% mogroside IIE by weight on a dry basis
e. from about 0.01% to about 30% mogroside V by weight on a dry basis; and
f. from about 0.01% to about 20% mogroside IIIE by weight on a dry basis.

In certain embodiments, the mogroside blends comprise siamenoside I and one or more of: isomogroside V, 11-oxomogroside V, 11-oxomogroside III, mogroside III, 11-oxoisomogroside V, or mogroside IIE.

In certain embodiments, the mogroside blends comprise about 300 to 500 ppm siamenoside I and about 10 to about 100 ppm of one or more of: isomogroside V, 11-oxomogroside V, 11-oxomogroside III, mogroside III, 11-oxoisomogroside V, or mogroside IIE. In certain embodiments, the mogroside blends comprise about 300 to 400 ppm siamenoside I and about 10 to about 50 ppm of one or more of isomogroside V, 11-oxomogroside V, 11-oxomogroside III, mogroside III, 11-oxoisomogroside V, or mogroside IIE.

In one embodiment, the mogroside blend comprises at least about 70% siamenoside I by weight on a dry basis and at least one of the following:
a. from 0.01% to about 25% isomogroside V by weight on a dry basis;
b. from about 0.01% to about 25% 11-oxomogroside V by weight on a dry basis;
c. from about 0.01% to about 2.5% 11-oxomogroside III by weight on a dry basis;
d. from about 0.01% to about 5% mogroside III by weight on a dry basis;
e. from about 0.01% to about 5% 11-oxoisomogroside V by weight on a dry basis;
f. from about 0.01% to about 5% mogroside IIE by weight on a dry basis;
g. from about 0.01% to about 10% mogroside IVA by weight on a dry basis;
h. from about 0.01% to about 20% mogroside IIIA2 by weight on a dry basis;
i. from about 0.01% to about 20% mogroside IIA by weight on a dry basis;
j. from about 0.01% to about 5% mogroside IIA1 by weight on a dry basis;
k. from about 0.01% to about 1% mogroside IA by weight on a dry basis;
l. from about 0.01% to about 1% mogroside IE by weight on a dry basis;
m. from about 0.01% to about 1% oxomogroside IIA1 by weight on a dry basis;
n. from about 0.01% to about 1% oxomogroside IIA2 by weight on a dry basis;
o. from about 0.01% to about 2.5% 11-oxomogroside IIA by weight on a dry basis;
p. from about 0.01% to about 20% 11-oxomogroside IIE by weight on a dry basis;
q. from about 0.01% to about 30% mogroside V by weight on a dry basis;
r. from about 0.01% to about 20% mogroside IIIE by weight on a dry basis;
s. from about 0.01% to about 20% 11-oxosiamenoside I by weight on a dry basis; and
t. from about 0.01% to about 20% 11-oxomogroside IIIE by weight on a dry basis.

In preferred embodiments, the mogroside blend contains minimal amounts of the following: mogroside IVA, mogroside IIIA2, mogroside IIA, mogroside IIA1, mogroside IIA2, mogroside IA, mogroside IE, oxomogroside IIA1, oxomogroside IIA2, 11-oxomogroside IIA, 11-oxomogroside IIE, and 11-oxomogroside III. These mogrosides have been found to increase the perception of bitterness in certain blends.

In one embodiment, the mogroside blend contains mogroside IVA in an amount of about 10% by weight or less on a dry basis, such as, for example, from about 0.01% to about 10% by weight, from about 0.01% to about 5% by weight, from about 0.01% to about 2.5% by weight, from about 0.01% to about 1% by weight, from about 1% to about 10% by weight, from about 1% to about 5% by weight, from about 1% to about 2.5% by weight, from about 2.5% to about 10% by weight, from about 2.5% to about 5% by weight or from about 5% to about 10% by weight.

In one embodiment, the mogroside blend contains mogroside IIIA2 in an amount of about 20% by weight or less on a dry basis, such as, for example, from about 0.01% to about 20% by weight, from about 0.01% to about 10% by weight, from about 0.01% to about 5% by weight, from about 0.01% to about 2.5% by weight, from about 0.01% to about 1% by weight, from about 1% to about 20% by weight, from about 1% to about 10% by weight, from about 1% to about 5% by weight, from about 1% to about 2.5% by weight, from about 2.5% to about 20% by weight, from about 2.5% to about 10% by weight, from about 2.5% to about 10% by weight, from about 5% to about 20% by weight, from about 5% to about 10% by weight, or from about 10% to about 20% by weight.

In one embodiment, the mogroside blend contains mogroside IA in an amount of about 20% by weight or less on a dry basis, such as, for example, from about 0.01% to about 20% by weight, from about 0.01% to about 10% by weight, from about 0.01% to about 5% by weight, from about 0.01% to about 2.5% by weight, from about 0.01% to about 1% by weight, from about 1% to about 20% by weight, from about 1% to about 10% by weight, from about 1% to about 5% by weight, from about 1% to about 2.5% by weight, from about 2.5% to about 20% by weight, from about 2.5% to about 10% by weight, from about 2.5% to about 5% by weight, from about 5% to about 20% by weight, from about 5% to about 10% by weight, or from about 10% to about 20% by weight.

In one embodiment, the mogroside blend contains mogroside IIA1 in an amount of about 5% by weight or less on a dry basis, such as, for example, from about 0.01% to about 5% by weight, from about 0.01% to about 2.5% by weight, from about 0.01% to about 1% by weight, from about 1% to about 5% by weight, from about 1% to about 2.5% by weight or from about 2.5% to about 5% by weight.

In one embodiment, the mogroside blend contains mogroside IIA2 in an amount of about 2.5% by weight or less on a dry basis, such as, for example, from about 0.01% to about 2.5% by weight, from about 0.01% to about 1% by weight, or from about 1% to about 2.5% by weight.

In one embodiment, the mogroside blend contains mogroside IA in an amount of about 1% by weight or less on a dry basis, such as, for example, from about 0.01% to about 1% by weight or about 0.5% to about 1% by weight.

In one embodiment, the mogroside blend contains mogroside IE in an amount of about 1% by weight or less on a dry basis, such as, for example, from about 0.01% to about 1% by weight, from about 0.1% to about 1% by weight, or about 0.5% to about 1% by weight.

In one embodiment, the mogroside blend contains oxomogroside IIA1 in an amount of about 1% by weight or less on a dry basis, such as, for example, from about 0.01% to about 1% by weight, from about 0.1% to about 1% by weight, or about 0.5% to about 1% by weight.

In one embodiment, the mogroside blend contains oxomogroside IIA2 in an amount of about 1% by weight or less on a dry basis, such as, for example, from about 0.01% to about 1% by weight, from about 0.1% to about 1% by weight, or about 0.5% to about 1% by weight.

In one embodiment, the mogroside blend contains 11-oxomogroside IIA, in an amount of about 2.5% by weight or less on a dry basis, such as, for example, from about 0.01% to about 2.5% by weight, from about 0.01% to about 1% by weight, or from about 1% to about 2.5% by weight.

In one embodiment, the mogroside blend contains 11-oxomogroside IIE, in an amount of about 20% by weight or less on a dry basis, such as, for example, from about 0.01% to about 20% by weight, from about 0.01% to about 10% by weight, from about 0.01% to about 5% by weight, from about 0.01% to about 2.5% by weight, from about 0.01% to about 1% by weight, from about 1% to about 20% by weight, from about 1% to about 10% by weight, from about 1% to about 5% by weight, from about 1% to about 2.5% by weight, from about 2.5% to about 20% by weight, from about 2.5% to about 10% by weight, from about 2.5% to about 5% by weight, from about 5% to about 20% by weight, from about 5% to about 10% by weight, or from about 10% to about 20% by weight.

In one embodiment, the mogroside blend contains 11-oxomogroside III in an amount of about 5% by weight or less on a dry basis, such as, for example, from about 0.01% to about 5% by weight, from about 0.01% to about 2.5% by weight, from about 0.01% to about 1% by weight, from about 1% to about 5% by weight, from about 1% to about 2.5% by weight or from about 2.5% to about 5% by weight.

It has been found that mogroside V, mogroside IIIE, 11-oxomogroside I, and 11-oxomogroside IIIE do not impact bitterness when present in certain amounts in blends with siamenoside I.

In certain embodiments, the mogroside blend contains mogroside V in an amount of about 30% by weight or less on a dry basis, such as, for example, from about 0.01% to about 30% by weight, from about 0.01% to about 20% by weight, from about 0.01% to about 10% by weight, from about 0.01% to about 5% by weight, from about 0.01% to about 2.5% by weight, from about 0.01% to about 1% by weight, from about 1% to about 30% by weight, from about 1% to about 20% by weight, from about 1% to about 10% by weight, from about 1% to about 5% by weight, from about 1% to about 2.5% by weight, from about 2.5% to about 30% by weight, from about 2.5% to about 20% by weight, from about 2.5% to about 10% by weight, from about 2.5% to about 5% by weight, from about 5% to about 30% by weight, from about 5% to about 20% by weight, from about 5% to about 10% by weight, from about 10% to about 30% by weight, from about 10% to about 20% by weight, or from about 20% to about 30% by weight.

In certain embodiments, the mogroside blend contains mogroside IIIE in an amount of about 20% by weight or less on a dry basis, such as, for example, from about 0.01% to about 20% by weight, from about 0.01% to about 10% by weight, from about 0.01% to about 5% by weight, from about 0.01% to about 2.5% by weight, from about 0.01% to about 1% by weight, from about 1% to about 20% by weight, from about 1% to about 10% by weight, from about 1% to about 5% by weight, from about 1% to about 2.5% by weight, from about 2.5% to about 20% by weight, from about 2.5% to about 10% by weight, from about 2.5% to about 5% by weight, from about 5% to about 20% by weight, from about 5% to about 10% by weight, or from about 10% to about 20% by weight.

In certain embodiments, the mogroside blend contains 11-oxosiamenoside I in an amount of about 20% by weight or less on a dry basis, such as, for example, from about 0.01% to about 20% by weight, from about 0.01% to about 10% by weight, from about 0.01% to about 5% by weight, from about 0.01% to about 2.5% by weight, from about 0.01% to about 1% by weight, from about 1% to about 20% by weight, from about 1% to about 10% by weight, from about 1% to about 5% by weight, from about 1% to about 2.5% by weight, from about 2.5% to about 20% by weight, from about 2.5% to about 10% by weight, from about 2.5% to about 5% by weight, from about 5% to about 20% by weight, from about 5% to about 10% by weight, or from about 10% to about 20% by weight.

In one embodiment, the mogroside blend contains 11-oxomogroside IIIE, in an amount of about 20% by weight or less on a dry basis, such as, for example, from about 0.01% to about 20% by weight, from about 0.01% to about 10% by weight, from about 0.01% to about 5% by weight, from about 0.01% to about 2.5% by weight, from about 0.01% to about 1% by weight, from about 1% to about 20% by weight, from about 1% to about 10% by weight, from about 1% to about 5% by weight, from about 1% to about 2.5% by weight, from about 2.5% to about 20% by weight, from about 2.5% to about 10% by weight, from about 2.5% to about 5% by weight, from about 5% to about 20% by weight, from about 5% to about 10% by weight, or from about 10% to about 20% by weight.

Structures for the compounds of the mogroside blends are shown below.

| Name | Structure |
|---|---|
| Siamenoside I | 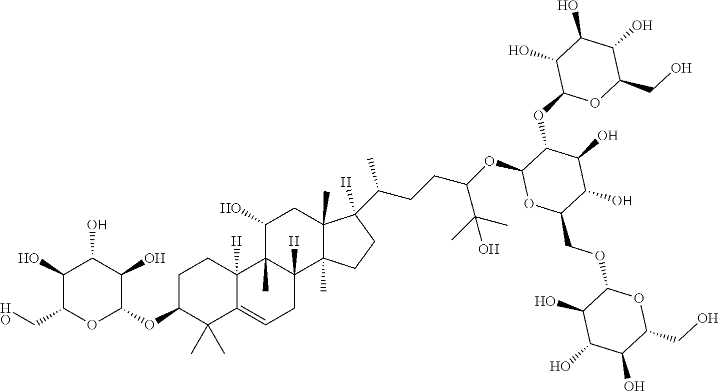 |
| Mogroside V | 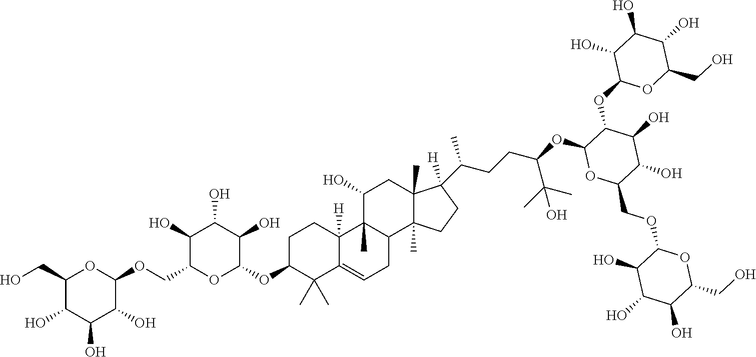 |
| Mogroside IIA2 | 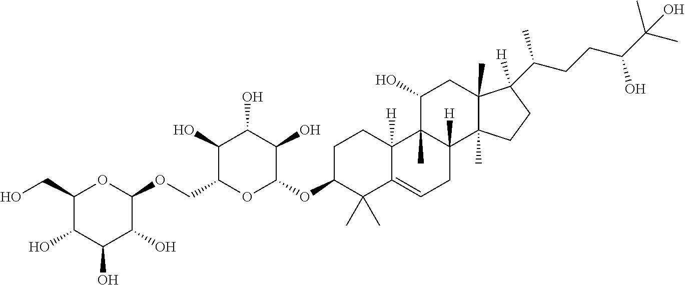 |
| Mogroside IIE | 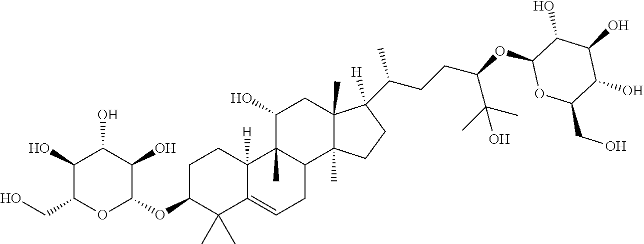 |
| 11-Oxomogroside V | 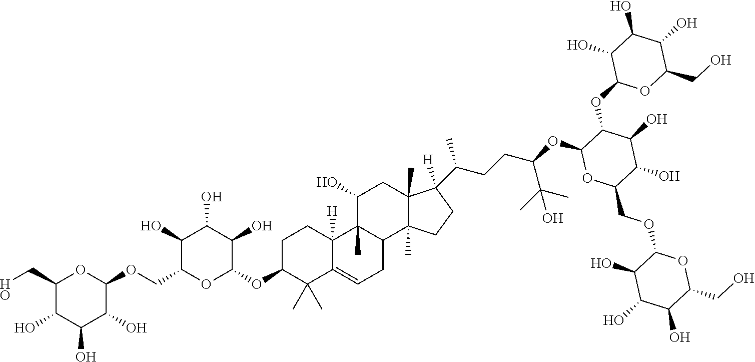 |
| Mogroside IVA | 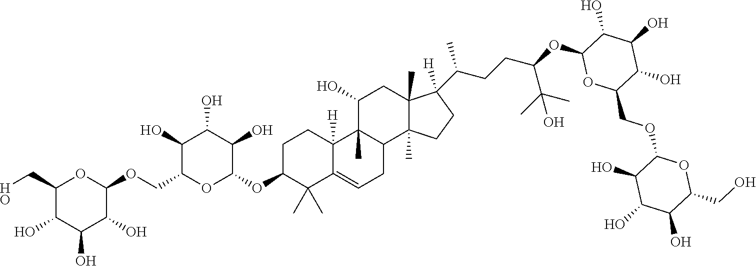 |
| Isomogroside V | 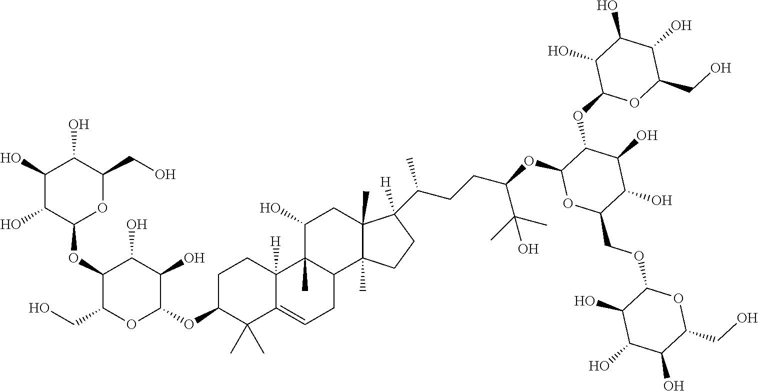 |
| Mogroside IIA1 | 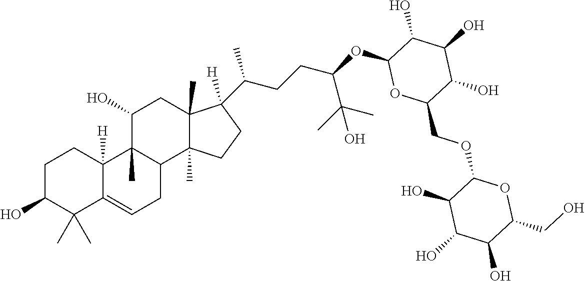 |
| Mogroside IIIA2 | 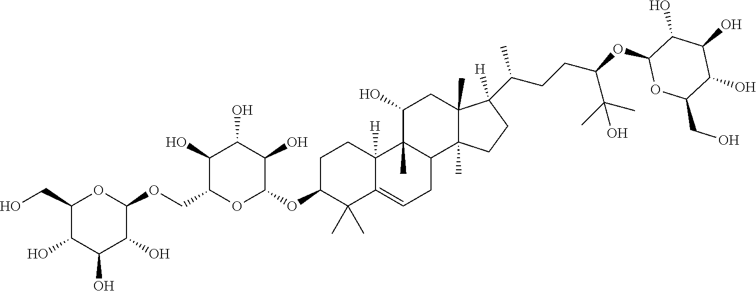 |
| Mogroside IIIE | 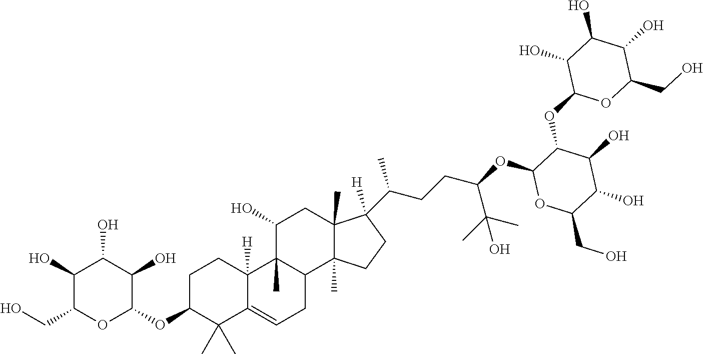 |
| Mogroside IA | 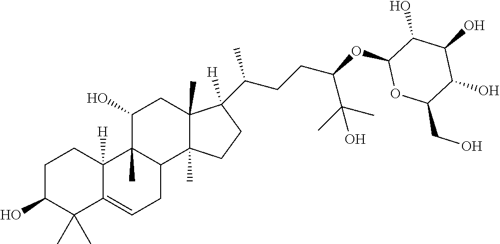 |
| Mogroside IE | 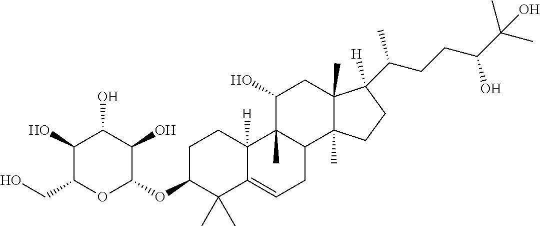 |
| Mogroside III | 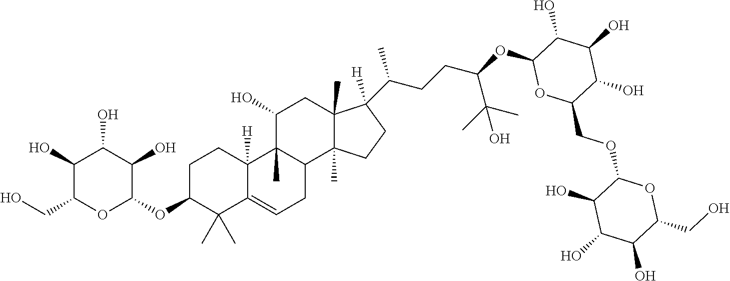 |
| 11- Oxosiamenoside I | 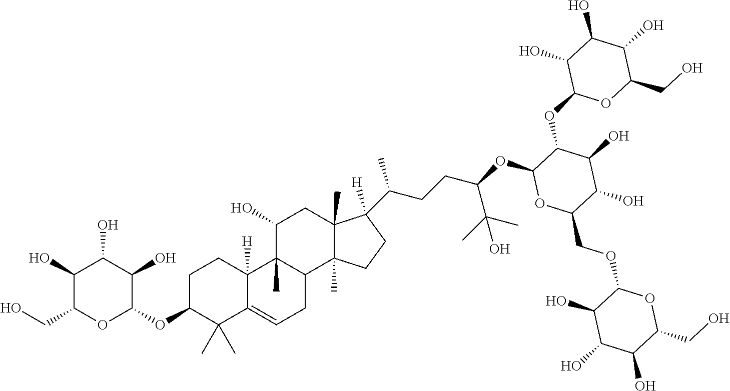 |
| 11-Oxomogroside IIIE | 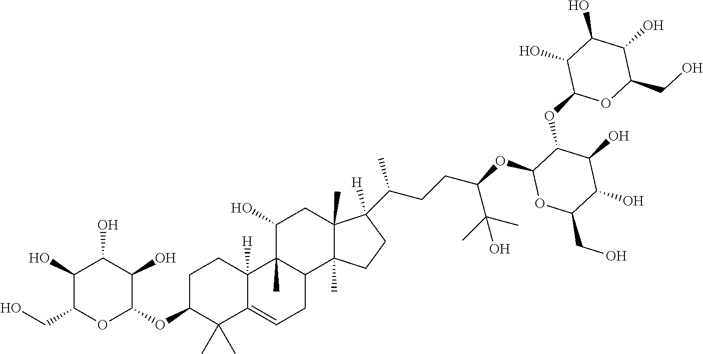 |
| Mogroside IIA | 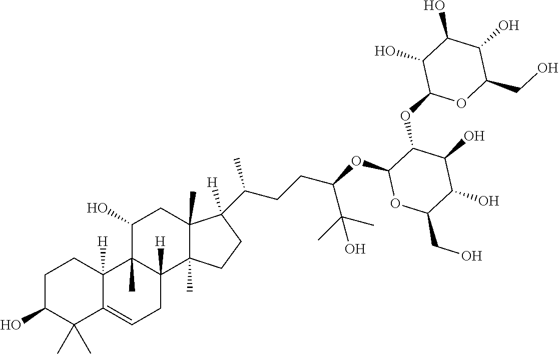 |
| 11-Oxomogroside IIA2 | 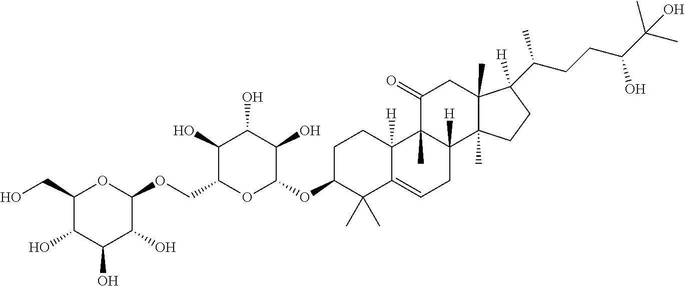 |
| 11- Oxoisomogroside V | 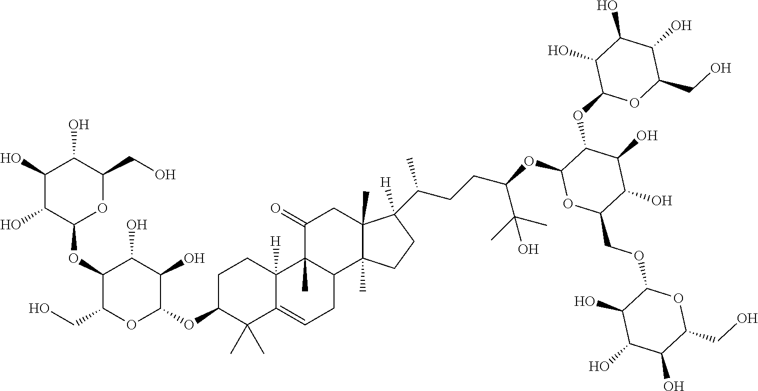 |
| 11-Oxomogroside III | 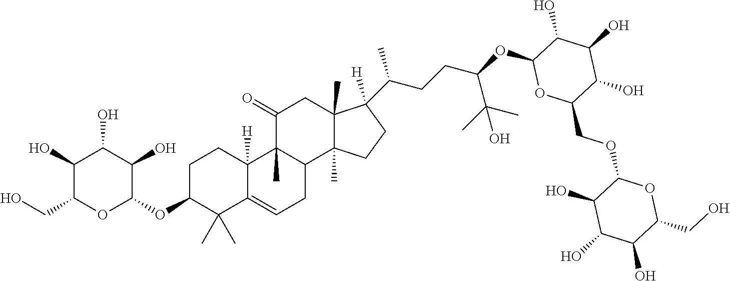 |
| 11-Oxomogroside IIE | 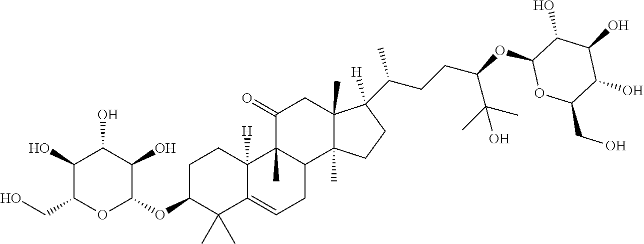 |
| 11-Oxomogroside IIA1 | 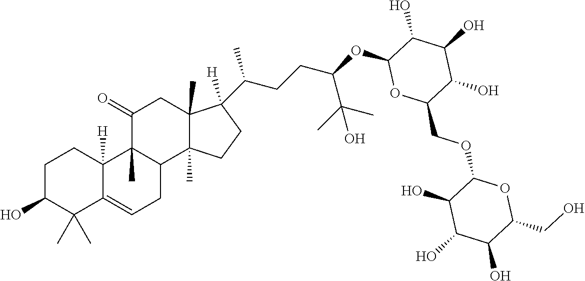 |
| 11-Oxomogroside IIA | 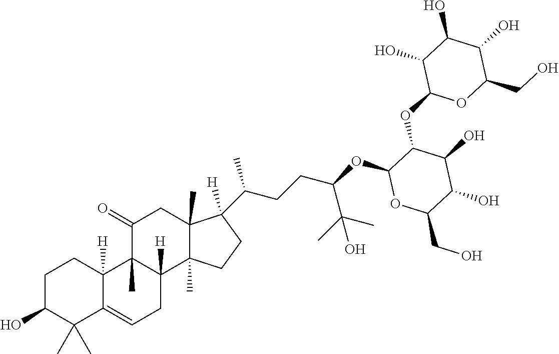 |

The mogroside blend sweetener is present in the beverage in a sweetening amount, i.e., an amount that is perceptibly sweet and above the blend's sweetness recognition threshold concentration.

The concentration of the mogroside sweetener can vary from about 10 ppm to about 600 ppm, such as, for example, from about 10 ppm to about 500 ppm, from about 10 ppm to about 400 ppm, from about 10 ppm to about 300 ppm, from about 10 ppm to about 200 ppm, from about 10 ppm to about 100 ppm, about 25 ppm to about 600 ppm, from about 25 ppm to about 500 ppm, from about 50 ppm to about 500 ppm, from about 25 ppm to about 400 ppm, from about 25 ppm to about 300 ppm, from about 25 ppm to about 200 ppm, from about 25 ppm to about 100 ppm, from about 100 ppm to about 600 ppm, from about 100 ppm to about 500 ppm, from about 100 ppm to about 400 ppm, from about 100 ppm to about 300 ppm, from about 100 ppm to about 200 ppm, from about 200 ppm to about 600 ppm, from about 200 ppm to about 500 ppm, from about 200 ppm to about 400 ppm, from about 200 ppm to about 300 ppm, from about 300 ppm to about 600 ppm, from about 300 ppm to about 500 ppm, from about 300 ppm to about 400 ppm, from about 400 ppm to about 600 ppm, from about 400 ppm to about 500 ppm or from about 500 ppm to about 600 ppm.

The total concentration of the mogroside blend can vary from about 10 ppm to about 600 ppm, such as, for example, from about 10 ppm to about 500 ppm, from about 10 ppm to about 400 ppm, from about 10 ppm to about 300 ppm, from about 10 ppm to about 200 ppm, from about 10 ppm to about 100 ppm, about 25 ppm to about 600 ppm, from about 25 ppm to about 500 ppm, from about 50 ppm to about 500 ppm, from about 25 ppm to about 400 ppm, from about 25 ppm to about 300 ppm, from about 25 ppm to about 200 ppm, from about 25 ppm to about 100 ppm, from about 100 ppm to about 600 ppm, from about 100 ppm to about 500 ppm, from about 100 ppm to about 400 ppm, from about 100 ppm to about 300 ppm, from about 100 ppm to about 200 ppm, from about 200 ppm to about 600 ppm, from about 200 ppm to about 500 ppm, from about 200 ppm to about 400 ppm, from about 250 ppm to about 400 ppm, from about 200 ppm to about 300 ppm, from about 300 ppm to about 600 ppm, from about 300 ppm to about 500 ppm, from about 300 ppm to about 400 ppm, from about 400 ppm to about 600 ppm, from about 400 ppm to about 500 ppm or from about 500 ppm to about 600 ppm.

In some embodiments, the mogroside blend sweetener is the sole sweetener in the beverage, i.e., the mogroside blend sweetener is the only substance that provides perceptible sweetness. In some embodiments, the beverages of the present invention do not contain added caloric sweeteners, e.g., sucrose or glucose.

In other embodiments, the beverage comprises one or more additional sweeteners.

In one embodiment, the additional sweetener is a high potency sweetener. Natural and synthetic high potency sweeteners are contemplated herein.

Non-limiting examples of natural high potency sweeteners include stevia sweetener and steviol glycoside sweeteners, such as rebaudioside M, rebaudioside D, rebaudioside A, rebaudioside AM, rebaudioside N, rebaudioside O, rebaudioside E, steviolmonoside, steviolbioside, rubusoside, dulcoside B, dulcoside A, rebaudioside B, rebaudioside G, stevioside, rebaudioside C, rebaudioside F, rebaudioside I, rebaudioside H, rebaudioside L, rebaudioside K, rebaudioside J, rebaudioside M2, rebaudioside D2, rebaudioside S, rebaudioside T, rebaudioside U, rebaudioside V, rebaudioside W, rebaudioside Z1, rebaudioside Z2, rebaudioside IX, enzymatically glucosylated steviol glycosides, and combinations thereof.

Steviol glycoside sweeteners can be provided in pure form or as part of a mixture. The steviol glycoside mixture sweetener typically has a total steviol glycoside content of about 95% by weight or greater on a dry basis. The remaining 5% comprises other non-steviol glycoside compounds, e.g. by-products from extraction or purification processes. In some embodiments, the steviol glycoside blend sweetener has a total steviol glycoside content of about 96% or greater, about 97% or greater, about 98% or greater or about 99% or greater.

In certain embodiments, a steviol glycoside mixture comprises at least about 5% of a particular steviol glycoside by weight on a dry basis, such as, for example, at least about 10%, at least about 20%, at least about 30%, at least about 40%, at least about 50%, at least about 60%, at least about 70%, at least about 80%, at least about 90%, at least about 95% or at least about 97%.

The concentration of the steviol glycoside sweetener in the beverage can vary from about 25 ppm to about 600 ppm, such as, for example, from about 25 ppm to about 500 ppm, from about 25 ppm to about 400 ppm, from about 25 ppm to about 300 ppm, from about 25 ppm to about 200 ppm, from about 25 ppm to about 100 ppm, from about 100 ppm to about 600 ppm, from about 100 ppm to about 500 ppm, from about 100 ppm to about 400 ppm, from about 100 ppm to about 300 ppm, from about 100 ppm to about 200 ppm, from about 200 ppm to about 600 ppm, from about 200 ppm to about 500 ppm, from about 200 ppm to about 400 ppm, from about 200 ppm to about 300 ppm, from about 300 ppm to about 600 ppm, from about 300 ppm to about 500 ppm, from about 300 ppm to about 400 ppm, from about 400 ppm to about 600 ppm, from about 400 ppm to about 500 ppm, or from about 500 ppm to about 600 ppm.

In a particular embodiment, the high potency sweetener is a steviol glycoside sweetener selected from the group consisting of rebaudioside A, rebaudioside M, rebaudioside AM, rebaudioside E, rebaudioside N, and rebaudioside B.

Other exemplary natural high potency sweeteners include Amai proteins, monatin and its salts (monatin SS, RR, RS, SR), curculin, glycyrrhizic acid and its salts, thaumatin (and variants thereof, e.g., thaumatin I and thaumatin II), monellin (and variants thereof), miraculin, mabinlin, brazzein (and variants thereof), sweet truffle protein (and variants thereof), hemandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, and cyclocarioside I.

Non-limiting examples of synthetic high potency sweeteners include sucralose, potassium acesulfame, aspartame, alitame, saccharin, neohesperidin dihydrochalcone synthetic derivatives, cyclamate, neotame, dulcin, suosan, cyclamate, saccharin, advantame, and salts thereof.

The concentration of the high potency sweetener can vary from about 1 ppm to about 900 ppm, such as, for example, from about 1 ppm to about 800 ppm, from about 1 ppm to about 700 ppm, from about 1 ppm to about 600 ppm, from about 1 ppm to about 500 ppm, from about 1 ppm to about 400 ppm, about 1 ppm to about 300 ppm, from about 1 ppm to about 200 ppm, from about 1 ppm to about 100 ppm, from about 1 ppm to about 50 ppm, from about 1 ppm to about 25 ppm, from about 1 ppm to about 15 ppm or about 1 ppm to about 10 ppm.

Exemplary rare sugar sweeteners include, but are not limited to, allulose (D-psicose), L-ribose, D-tagatose, L-glucose, L-fucose, L-arabinose, D-turanose, D-leubiose (D-leucose), and combinations thereof.

The amount of rare sugar sweetener in the beverage depends on the identity of the rare sugar and the permitted regulatory limit. In one embodiment, a beverage comprises a rare sugar in an amount from about 0.1 wt % to 12 wt %, from about 0.1 wt % to about 5 wt %, from about 0.1 wt % to about 2.5 wt %, about 0.1 wt % to about 2 wt %, or about 0.1 wt % to about 1 wt %.

Suitable carbohydrate sweeteners include, but are not limited to, sucrose, glyceraldehyde, dihydroxyacetone, erythrose, threose, erythrulose, arabinose, lyxose, ribose, xylose, ribulose, xylulose, allose, altrose, galactose, glucose, gulose, idose, mannose, talose, fructose, allulose, sorbose, tagatose, mannoheptulose, sedoheltulose, octolose, fucose, rhamnose, arabinose, turanose, sialose, high fructose corn syrup, high fructose starch-based syrup and combinations thereof.

The amount of the carbohydrate sweetener in the beverage can vary from about 1 wt % to about 10 wt %, such as, for example, from about 4 wt % to about 10 wt %, about 5 wt % to about 10 wt %, about 6 wt % to about 10 wt %, about 7 wt % to about 10 wt %, about 8 wt % to about 10 wt % or about 9 wt % to about 10 wt %. In certain embodiments, the carbohydrate sweetener is present in an amount from about 1 wt % to about 3 wt %.

In a particular embodiment, the caloric sweetener is selected from the group consisting of sucrose, high fructose corn syrup, high fructose starch-based syrups, fructose, glucose and combinations thereof.

Other suitable sweeteners include allulose, allose, sucrose, fructose, glucose, propylene glycol, glycerol, erythritol, arabinitol, maltitol, lactitol, sorbitol, mannitol, xylitol, tagatose, trehalose, galactose, rhamnose, cyclodextrin (e.g., α-cyclodextrin, β-cyclodextrin, and γ-cyclodextrin), ribulose, threose, arabinose, xylose, lyxose, allose, altrose, mannose, idose, lactose, maltose, invert sugar, isotrehalose, neotrehalose, palatinose isomaltulose, erythrose, deoxyribose, gulose, idose, talose, erythrulose, xylulose, allulose, turanose, cellobiose, glucosamine, mannosamine, fucose, fuculose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, ketotriose (dihydroxyacetone), aldotriose (glyceraldehyde), nigero-oligosaccharides, fructooligosaccharides (kestose, nystose and the like), maltotetraose, inaltotriol, tetrasaccharides, mannan-oligosaccharides, malto-oligosaccharides (maltotriose, maltotetraose, maltopentaose, maltohexaose, maltoheptaose and the like), dextrins, lactulose, melibiose, raffmose, rhamnose, ribose, isomerized, liquid sugars such as high fructose corn/starch syrup (“HFCS/HFSS,” e.g., HFCS55, HFCS42, or HFCS90), coupling sugars, soybean oligosaccharides, glucose syrup and combinations thereof. It is understood that D- or L-configurations can be used when applicable.

Exemplary sugar alcohol sweeteners include, but are not limited to, sorbitol, mannitol, lactitol, maltitol, xylitol, erythritol and combinations thereof.

The at least one sugar alcohol can be present in an amount from about 0.1 wt % to about 3.5 wt %, such as, for example, from about 0.5 wt % to about 3.5 wt %, from about 0.5 wt % to about 3.0 wt %, from about 0.5 wt % to about 2.5 wt %, from about 0.5 wt % to about 2.0 wt %, from about 0.5 wt % to about 1.5 wt %, from about 0.5 wt % to about 1.0 wt %, from about 1.0 wt % to about 3.5 wt %, from about 1.0 wt % to about 3.0 wt %, from about 1.0 wt % to about 2.5 wt %, from about 1.0 wt % to about 2.0 wt %, from about 1.0 wt % to about 1.5 wt %, from about 1.5 wt % to about 3.5 wt %, from about 1.5 wt % to about 3.0 wt %, from about 1.5 wt % to about 2.5 wt %, from about 1.5 wt % to about 2.0 wt %, from about 2.0 wt % to about 3.5 wt %, from about 2.0 wt % to about 3.0 wt %, from about 2.0 wt % to about 2.5 wt %, from about 2.5 wt % to about 3.5 wt %, from about 2.5 wt % to about 3.0 wt % or from about 3.0 wt % to about 3.5 wt %.

A diet beverage of the present invention can be any type of known beverage, e.g., a full-calorie beverage, reduced calorie beverage or zero-calorie beverage.

In exemplary embodiments, the beverage is a carbonated beverage. Suitable carbonated beverages include, but are not limited to, frozen carbonated beverages, enhanced sparkling beverages, cola, fruit-flavored sparkling beverages (e.g. lemon-lime, orange, grape, strawberry and pineapple), ginger-ale, soft drinks and root beer.

In other embodiments, the beverage is a non-carbonated beverage. Suitable non-carbonated beverages include, but are not limited to, fruit juice, fruit-flavored juice, juice drinks, nectars, vegetable juice, vegetable-flavored juice, sports drinks, energy drinks, enhanced water drinks, enhanced water with vitamins, near water drinks (e.g., water with natural or synthetic flavorants), coconut water, tea type drinks (e.g. black tea, green tea, red tea, oolong tea), coffee, cocoa drink, beverage containing milk components (e.g. milk beverages, coffee containing milk components, café au lait, milk tea, fruit milk beverages), beverages containing cereal extracts and smoothies.

In one embodiment, a juice beverage comprises not-from-concentrate (NFC) or from-concentrate (FC) juices. In certain exemplary embodiments, the juice beverage comprises citrus juice. In certain exemplary embodiments, the juice beverage comprises a not-from-concentrate (NFC) orange juice. Other types of fruit or vegetable juices include, but are not limited to, juices of citrus fruit (e.g., orange, grapefruit, lemon, lime, tangerine, tangelo), apricot, apple, kumquat, mango, pear, peach, pineapple, papaya, passion fruit, grape, strawberry, raspberry, cranberry, currant, bean, blueberry, blackberry, acai, lychee, kiwi, pomegranate, watermelon, rhubarb, aronia, tomato, celery, cucurbits, onion, watercress, cucumber, carrot, parsley, beet, asparagus, potato, turnip, rutabaga, and combinations thereof.

In one embodiment, the beverage is an alcoholic beverage. Both carbonated and non-carbonated alcoholic beverages are contemplated herein. Examples include brewed alcohols, spirits (e.g., gin, vodka, rum, tequila), liquors, whiskeys (e.g., whiskey, brandy), shochu, and fermented beverages (e.g., mead, sake, wine, and beer). Additional alcoholic beverages include champagne, ciders, wine coolers, and hard seltzers.

Beverages comprise a beverage matrix, i.e. the basic ingredient in which the ingredients are dissolved. In one embodiment, a beverage comprises water of beverage quality as the matrix, such as, for example deionized water, distilled water, reverse osmosis water, carbon-treated water, purified water, demineralized water and combinations thereof, can be used. Additional suitable beverage matrices include, but are not limited to phosphoric acid, phosphate buffer, citric acid, citrate buffer and carbon-treated water.

In one embodiment, the beverage is a cola beverage. A cola beverage matrix typically contains phosphoric acid.

A non-limiting example of the pH range of the beverage may be from about 1.8 to about 10. A further example includes a pH range from about 2 to about 5. In a particular embodiment, the pH of beverage can be from about 2.5 to about 4.2.

In a more particular embodiment, the pH of the beverage is from about 3.0 to about 3.5. It has been found that use of the C2-C9 organic acid salts described herein has a slightly basifying effect, increasing the pH from about 0.1 to about 0.3 pH units.

The titratable acidity of a beverage may, for example, range from about 0.01 to about 1.0% by weight of beverage.

In one embodiment, the sparkling beverage product has an acidity from about 0.01 to about 1.0% by weight of the beverage, such as, for example, from about 0.05% to about 0.25% by weight of beverage.

The carbonation of a sparkling beverage product has 0.1 to about 2% (w/w) of carbon dioxide or its equivalent, for example, from about 0.1 to about 1.0% (w/w).

The beverage can be caffeinated (i.e., it contains caffeine) or non-caffeinated.

The temperature of a beverage may, for example, range from about 4° C. to about 100° C., such as, for example, from about 4° C. to about 25° C.

In one embodiment, a beverage has a sucrose equivalence (SE) of about 1% (w/v), such as, for example, about 2%, about 3%, about 4%, about 5%, about 6%, about 7%, about 8%, about 9%, about 10%, about 11%, about 12%, about 13%, about 14% or any range between these values.

In another embodiment, the beverage has a SE from about 2% to about 14%, such as, for example, from about 2% to about 10%, from about 2% to about 5%, from about 5% to about 15%, from about 5% to about 10% or from about 10% to about 15%.

The amount of sucrose, and thus another measure of sweetness, in a reference solution may be described in degrees Brix (° Bx). One degree Brix is 1 gram of sucrose in 100 grams of solution and represents the strength of the solution as percentage by weight (% w/w) (strictly speaking, by mass). In embodiments where the beverages are sweetened with sugar). In embodiments where the beverage comprises sucrose, the beverage can be from about 4° Bx to about 11° Bx, from about 4° Bx to about 10° Bx, from about 4° Bx to about 8° Bx, from about 4° Bx to about 6° Bx, from about 5° Bx to about 11° Bx, from about 5° Bx to about 10° Bx, from about 5° Bx to about 8° Bx, from about 6° Bx to about 11° Bx, from about 6° Bx to about 10° Bx, from about 6° Bx to about 8° Bx, from about from about 7° Bx to about 11° Bx, from about 7° Bx to about 10° Bx, from about 8° Bx to about 11° Bx, from about 8° Bx to about 10° Bx, from about 9° Bx to about 11° Bx, from about 9° Bx to about 10° Bx or from about 10° Bx to about 11° Bx.

In one embodiment, a diet beverage of the present invention comprises a mogroside blend described herein in a concentration from about 300 ppm to about 600 ppm, preferably from about 300 ppm to about 500 ppm. The diet beverage preferably has a sucrose equivalence of at least about 5% (w/v), preferably from about 5% to about 15% (w/v) or from about 8% to about 10% (w/v). In particular embodiments, the mogroside blend is the sole sweetener in the beverage.

The beverages described herein optionally include at least one salt, such as amino acid salts, poly-amino acid salts, sugar acid salts, organic acid salts, organic base salts, and inorganic salts.

Salts can be used to improve the taste attributes of the beverages and beverage products. Exemplary taste attribute modulations include decreasing or eliminating bitterness, decreasing or eliminating bitter linger, decreasing or eliminating sourness, decreasing or eliminating astringency, decreasing or eliminating saltiness, decreasing or eliminating metallic notes, improving mouthfeel, decreasing or eliminating sweetness linger, increasing sweetness onset and increasing sweetness intensity.

The concentration of the at least one salt in the beverage can be from about 250 ppm to about 500 ppm, such as, for example, from about 250 ppm to about 400 ppm, from about 250 ppm to about 300 ppm, from about 300 ppm to about 500 ppm, from about 300 ppm to about 400 ppm, or from about 400 ppm to about 500 ppm. It has been found that such concentrations of the at least one salt provide superior results compared to both lower and higher concentrations. For example, concentrations of 750-1,000 ppm provide undesirable flavor changes.

In certain embodiments, the beverages comprise at least one organic acid salt selected from the group consisting of: sodium gluconate, sodium citrate, sodium lactate, potassium gluconate, potassium citrate, potassium lactate, calcium gluconate, calcium citrate, calcium lactate, calcium lactate gluconate, magnesium gluconate, magnesium citrate, magnesium lactate, magnesium lactate gluconate, and anhydrous and hydrate forms thereof.

In certain embodiments, the beverages comprise at least one salt selected from the group consisting of sodium gluconate, sodium citrate, sodium lactate, potassium gluconate, potassium citrate, and potassium lactate. The beverages may comprise at least one salt selected from sodium gluconate, sodium citrate, sodium lactate, potassium gluconate, potassium citrate, and potassium lactate. In certain embodiments, the at least one salt is a sodium salt selected from the group consisting of sodium gluconate, sodium citrate, sodium lactate, and combinations thereof. In other certain embodiments, the at least one salt is a potassium salt selected from the group consisting of potassium gluconate, potassium citrate, potassium lactate, and combinations thereof.

The beverages described herein optionally include at least one functional ingredient described herein below.

Exemplary functional ingredients include, but are not limited to, saponins, antioxidants, dietary fiber sources, fatty acids, vitamins, glucosamine, minerals, preservatives, hydration agents, probiotics, prebiotics, weight management agents, osteoporosis management agents, phytoestrogens, long chain primary aliphatic saturated alcohols, phytosterols and combinations thereof.

In certain embodiments, the functional ingredient is at least one saponin. As used herein, the at least one saponin may comprise a single saponin or a plurality of saponins as a functional ingredient for the composition provided herein. Saponins are glycosidic natural plant products comprising an aglycone ring structure and one or more sugar moieties. Non-limiting examples of specific saponins for use in particular embodiments of the invention include group A acetyl saponin, group B acetyl saponin, and group E acetyl saponin. Several common sources of saponins include soybeans, which have approximately 5% saponin content by dry weight, soapwort plants (Saponaria), the root of which was used historically as soap, as well as alfalfa, aloe, asparagus, grapes, chickpeas, yucca, and various other beans and weeds. Saponins may be obtained from these sources by using extraction techniques well known to those of ordinary skill in the art. A description of conventional extraction techniques can be found in U.S. Pat. Appl. No. 2005/0123662.

In certain embodiments, the functional ingredient is at least one antioxidant. As used herein, “antioxidant” refers to any substance which inhibits, suppresses, or reduces oxidative damage to cells and biomolecules.

Examples of suitable antioxidants for embodiments of this invention include, but are not limited to, vitamins, vitamin cofactors, minerals, hormones, carotenoids, carotenoid terpenoids, non-carotenoid terpenoids, flavonoids, flavonoid polyphenolics (e.g., bioflavonoids), flavonols, flavones, phenols, polyphenols, esters of phenols, esters of polyphenols, nonflavonoid phenolics, isothiocyanates, and combinations thereof. In some embodiments, the antioxidant is vitamin A, vitamin C, vitamin E, ubiquinone, mineral selenium, manganese, melatonin, α-carotene, β-carotene, lycopene, lutein, zeanthin, crypoxanthin, reservatol, eugenol, quercetin, catechin, gossypol, hesperetin, curcumin, ferulic acid, thymol, hydroxytyrosol, tumeric, thyme, olive oil, lipoic acid, glutathinone, gutamine, oxalic acid, tocopherol-derived compounds, butylated hydroxyanisole (BHA), butylated hydroxytoluene (BHT), ethylenediaminetetraacetic acid (EDTA), tert-butylhydroquinone, acetic acid, pectin, tocotrienol, tocopherol, coenzyme Q10, zeaxanthin, astaxanthin, canthaxantin, saponins, limonoids, kaempfedrol, myricetin, isorhamnetin, proanthocyanidins, quercetin, rutin, luteolin, apigenin, tangeritin, hesperetin, naringenin, erodictyol, flavan-3-ols (e.g., anthocyanidins), gallocatechins, epicatechin and its gallate forms, epigallocatechin and its gallate forms (ECGC) theaflavin and its gallate forms, thearubigins, isoflavone, phytoestrogens, genistein, daidzein, glycitein, anythocyanins, cyaniding, delphinidin, malvidin, pelargonidin, peonidin, petunidin, ellagic acid, gallic acid, salicylic acid, rosmarinic acid, cinnamic acid and its derivatives (e.g., ferulic acid), chlorogenic acid, chicoric acid, gallotannins, ellagitannins, anthoxanthins, betacyanins and other plant pigments, silymarin, citric acid, lignan, antinutrients, bilirubin, uric acid, R-α-lipoic acid, N-acetylcysteine, emblicanin, apple extract, apple skin extract (applephenon), rooibos extract red, rooibos extract, green, hawthorn berry extract, red raspberry extract, green coffee antioxidant (GCA), aronia extract 20%, grape seed extract (VinOseed), cocoa extract, hops extract, mangosteen extract, mangosteen hull extract, cranberry extract, pomegranate extract, pomegranate hull extract, pomegranate seed extract, hawthom berry extract, pomella pomegranate extract, cinnamon bark extract, grape skin extract, bilberry extract, pine bark extract, pycnogenol, elderberry extract, mulberry root extract, wolfberry (gogi) extract, blackberry extract, blueberry extract, blueberry leaf extract, raspberry extract, turmeric extract, citrus bioflavonoids, black currant, ginger, acai powder, green coffee bean extract, green tea extract, and phytic acid, or combinations thereof. In alternate embodiments, the antioxidant is a synthetic antioxidant such as butylated hydroxytolune or butylated hydroxyanisole, for example. Other sources of suitable antioxidants for embodiments of this invention include, but are not limited to, fruits, vegetables, tea, cocoa, chocolate, spices, herbs, rice, organ meats from livestock, yeast, whole grains, or cereal grains.

Particular antioxidants belong to the class of phytonutrients called polyphenols (also known as “polyphenolics”), which are a group of chemical substances found in plants, characterized by the presence of more than one phenol group per molecule. Suitable polyphenols for embodiments of this invention include catechins, proanthocyanidins, procyanidins, anthocyanins, quercerin, rutin, reservatrol, isoflavones, curcumin, punicalagin, ellagitannin, hesperidin, naringin, citrus flavonoids, chlorogenic acid, other similar materials, and combinations thereof.

In one embodiment, the antioxidant is a catechin such as, for example, epigallocatechin gallate (EGCG). In another embodiment, the antioxidant is chosen from proanthocyanidins, procyanidins or combinations thereof. In particular embodiments, the antioxidant is an anthocyanin. In still other embodiments, the antioxidant is chosen from quercetin, rutin or combinations thereof. In one embodiment, the antioxidant is reservatrol. In another embodiment, the antioxidant is an isoflavone. In still another embodiment, the antioxidant is curcumin. In a yet further embodiment, the antioxidant is chosen from punicalagin, ellagitannin or combinations thereof. In a still further embodiment, the antioxidant is chlorogenic acid.

In certain embodiments, the functional ingredient is at least one dietary fiber. Numerous polymeric carbohydrates having significantly different structures in both composition and linkages fall within the definition of dietary fiber. Such compounds are well known to those skilled in the art, non-limiting examples of which include non-starch polysaccharides, lignin, cellulose, methylcellulose, the hemicelluloses, β-glucans, pectins, gums, mucilage, waxes, inulins, oligosaccharides, fructooligosaccharides, cyclodextrins, chitins, and combinations thereof. Although dietary fiber generally is derived from plant sources, indigestible animal products such as chitins are also classified as dietary fiber. Chitin is a polysaccharide composed of units of acetylglucosamine joined by β(1-4) linkages, similar to the linkages of cellulose.

In certain embodiments, the functional ingredient is at least one fatty acid. As used herein, “fatty acid” refers to any straight chain monocarboxylic acid and includes saturated fatty acids, unsaturated fatty acids, long chain fatty acids, medium chain fatty acids, short chain fatty acids, fatty acid precursors (including omega-9 fatty acid precursors), and esterified fatty acids. As used herein, “long chain polyunsaturated fatty acid” refers to any polyunsaturated carboxylic acid or organic acid with a long aliphatic tail. As used herein, “omega-3 fatty acid” refers to any polyunsaturated fatty acid having a first double bond as the third carbon-carbon bond from the terminal methyl end of its carbon chain. In particular embodiments, the omega-3 fatty acid may comprise a long chain omega-3 fatty acid. As used herein, “omega-6 fatty acid” any polyunsaturated fatty acid having a first double bond as the sixth carbon-carbon bond from the terminal methyl end of its carbon chain.

Suitable omega-3 fatty acids for use in embodiments of the present invention can be derived from algae, fish, animals, plants, or combinations thereof, for example. Examples of suitable omega-3 fatty acids include, but are not limited to, linolenic acid, alpha-linolenic acid, eicosapentaenoic acid, docosahexaenoic acid, stearidonic acid, eicosatetraenoic acid and combinations thereof. In some embodiments, suitable omega-3 fatty acids can be provided in fish oils, (e.g., menhaden oil, tuna oil, salmon oil, bonito oil, and cod oil), microalgae omega-3 oils or combinations thereof. In particular embodiments, suitable omega-3 fatty acids may be derived from commercially available omega-3 fatty acid oils such as Microalgae DHA oil (from Martek, Columbia, MD), OmegaPure (from Omega Protein, Houston, TX), Marinol C-38 (from Lipid Nutrition, Channahon, IL), Bonito oil and MEG-3 (from Ocean Nutrition, Dartmouth, NS), Evogel (from Symrise, Holzminden, Germany), Marine Oil, from tuna or salmon (from Arista Wilton, CT), OmegaSource 2000, Marine Oil, from menhaden and Marine Oil, from cod (from OmegaSource, RTP, NC).

Suitable omega-6 fatty acids include, but are not limited to, linoleic acid, gamma-linolenic acid, dihommo-gamma-linolenic acid, arachidonic acid, eicosadienoic acid, docosadienoic acid, adrenic acid, docosapentaenoic acid and combinations thereof.

Suitable esterified fatty acids for embodiments of the present invention include, but are not limited to, monoacylgycerols containing omega-3 and/or omega-6 fatty acids, diacylgycerols containing omega-3 and/or omega-6 fatty acids, or triacylgycerols containing omega-3 and/or omega-6 fatty acids and combinations thereof.

In certain embodiments, the functional ingredient is glucosamine, optionally further comprising chondroitin sulfate.

In certain embodiments, the functional ingredient is at least one preservative. In particular embodiments, the preservative is chosen from antimicrobials, antioxidants, antienzymatics or combinations thereof. Non-limiting examples of antimicrobials include sulfites, propionates, benzoates, sorbates, nitrates, nitrites, bacteriocins, salts, sugars, acetic acid, dimethyl dicarbonate (DMDC), ethanol, and ozone. In one embodiment, the preservative is a sulfite. Sulfites include, but are not limited to, sulfur dioxide, sodium bisulfite, and potassium hydrogen sulfite. In another embodiment, the preservative is a propionate. Propionates include, but are not limited to, propionic acid, calcium propionate, and sodium propionate. In yet another embodiment, the preservative is a benzoate. Benzoates include, but are not limited to, sodium benzoate and benzoic acid. In still another embodiment, the preservative is a sorbate. Sorbates include, but are not limited to, potassium sorbate, sodium sorbate, calcium sorbate, and sorbic acid. In a still further embodiment, the preservative is a nitrate and/or a nitrite. Nitrates and nitrites include, but are not limited to, sodium nitrate and sodium nitrite. In another embodiment, the at least one preservative is a bacteriocin, such as, for example, nisin. In still another embodiment, the preservative is ethanol. In yet another embodiment, the preservative is ozone. Non-limiting examples of antienzymatics suitable for use as preservatives in particular embodiments of the invention include ascorbic acid, citric acid, and metal chelating agents such as ethylenediaminetetraacetic acid (EDTA).

In certain embodiments, the functional ingredient is at least one hydration agent. In another particular embodiment, the hydration agent is a carbohydrate to supplement energy stores burned by muscles. Suitable carbohydrates for use in particular embodiments of this invention are described in U.S. Pat. Nos. 4,312,856, 4,853,237, 5,681,569, and 6,989,171. Non-limiting examples of suitable carbohydrates include monosaccharides, disaccharides, oligosaccharides, complex polysaccharides or combinations thereof. Non-limiting examples of suitable types of monosaccharides for use in particular embodiments include trioses, tetroses, pentoses, hexoses, heptoses, octoses, and nonoses. Non-limiting examples of specific types of suitable monosaccharides include glyceraldehyde, dihydroxyacetone, erythrose, threose, erythrulose, arabinose, lyxose, ribose, xylose, ribulose, xylulose, allose, altrose, galactose, glucose, gulose, idose, mannose, talose, fructose, allulose, sorbose, tagatose, mannoheptulose, sedoheltulose, octolose, and sialose. Non-limiting examples of suitable disaccharides include sucrose, lactose, and maltose. Non-limiting examples of suitable oligosaccharides include saccharose, maltotriose, and maltodextrin. In other particular embodiments, the carbohydrates are provided by a corn syrup, starch-based syrup, a beet sugar, a cane sugar, a juice, or a tea.

In another particular embodiment, the hydration agent is a flavanol that provides cellular rehydration. Flavanols are a class of natural substances present in plants, and generally comprise a 2-phenylbenzopyrone molecular skeleton attached to one or more chemical moieties. Non-limiting examples of suitable flavanols for use in particular embodiments of this invention include catechin, epicatechin, gallocatechin, epigallocatechin, epicatechin gallate, epigallocatechin 3-gallate, theaflavin, theaflavin 3-gallate, theaflavin 3′-gallate, theaflavin 3,3′ gallate, thearubigin or combinations thereof. Several common sources of flavanols include tea plants, fruits, vegetables, and flowers. In preferred embodiments, the flavanol is extracted from green tea.

In a particular embodiment, the hydration agent is a glycerol solution to enhance exercise endurance. The ingestion of a glycerol containing solution has been shown to provide beneficial physiological effects, such as expanded blood volume, lower heart rate, and lower rectal temperature.

In certain embodiments, the functional ingredient is chosen from at least one probiotic, prebiotic and combination thereof. The probiotic is a beneficial microorganism that affects the human body's naturally-occurring gastrointestinal microflora. Examples of probiotics include, but are not limited to, bacteria of the genus Lactobacilli, Bifidobacteria, Streptococci, or combinations thereof, that confer beneficial effects to humans. In particular embodiments of the invention, the at least one probiotic is chosen from the genus Lactobacilli. According to other particular embodiments of this invention, the probiotic is chosen from the genus Bifidobacteria. In a particular embodiment, the probiotic is chosen from the genus Streptococcus.

Probiotics that may be used in accordance with this invention are well-known to those of skill in the art. Non-limiting examples of foodstuffs comprising probiotics include yogurt, sauerkraut, kefir, kimchi, fermented vegetables, and other foodstuffs containing a microbial element that beneficially affects the host animal by improving the intestinal microbalance.

Prebiotics, in accordance with the embodiments of this invention, include, without limitation, mucopolysaccharides, oligosaccharides, polysaccharides, amino acids, vitamins, nutrient precursors, proteins and combinations thereof. According to a particular embodiment of this invention, the prebiotic is chosen from dietary fibers, including, without limitation, polysaccharides and oligosaccharides. Non-limiting examples of oligosaccharides that are categorized as prebiotics in accordance with particular embodiments of this invention include fructooligosaccharides, inulins, isomalto-oligosaccharides, lactilol, lactosucrose, lactulose, pyrodextrins, soy oligosaccharides, transgalacto-oligosaccharides, and xylo-oligosaccharides. In other embodiments, the prebiotic is an amino acid. Although a number of known prebiotics break down to provide carbohydrates for probiotics, some probiotics also require amino acids for nourishment.

Prebiotics are found naturally in a variety of foods including, without limitation, bananas, berries, asparagus, garlic, wheat, oats, barley (and other whole grains), flaxseed, tomatoes, Jerusalem artichoke, onions and chicory, greens (e.g., dandelion greens, spinach, collard greens, chard, kale, mustard greens, turnip greens), and legumes (e.g., lentils, kidney beans, chickpeas, navy beans, white beans, black beans).

In certain embodiments, the functional ingredient is at least one weight management agent. As used herein, “a weight management agent” includes an appetite suppressant and/or a thermogenesis agent. As used herein, the phrases “appetite suppressant”, “appetite satiation compositions”, “satiety agents”, and “satiety ingredients” are synonymous. The phrase “appetite suppressant” describes macronutrients, herbal extracts, exogenous hormones, anorectics, anorexigenics, pharmaceutical drugs, and combinations thereof, that when delivered in an effective amount, suppress, inhibit, reduce, or otherwise curtail a person's appetite. The phrase “thermogenesis agent” describes macronutrients, herbal extracts, exogenous hormones, anorectics, anorexigenics, pharmaceutical drugs, and combinations thereof, that when delivered in an effective amount, activate or otherwise enhance a person's thermogenesis or metabolism.

Suitable weight management agents include macronutrients selected from the group consisting of proteins, carbohydrates, dietary fats, and combinations thereof. Consumption of proteins, carbohydrates, and dietary fats stimulates the release of peptides with appetite-suppressing effects. For example, consumption of proteins and dietary fats stimulates the release of the gut hormone cholecytokinin (CCK), while consumption of carbohydrates and dietary fats stimulates release of Glucagon-like peptide 1 (GLP-1).

Suitable macronutrient weight management agents also include carbohydrates. Carbohydrates generally comprise sugars, starches, cellulose and gums that the body converts into glucose for energy. Carbohydrates often are classified into two categories, digestible carbohydrates (e.g., monosaccharides, disaccharides, and starch) and non-digestible carbohydrates (e.g., dietary fiber). Studies have shown that non-digestible carbohydrates and complex polymeric carbohydrates having reduced absorption and digestibility in the small intestine stimulate physiologic responses that inhibit food intake. Accordingly, the carbohydrates embodied herein desirably comprise non-digestible carbohydrates or carbohydrates with reduced digestibility. Non-limiting examples of such carbohydrates include polydextrose; inulin; monosaccharide-derived polyols such as erythritol, mannitol, xylitol, and sorbitol; disaccharide-derived alcohols such as isomalt, lactitol, and maltitol; and hydrogenated starch hydrolysates. Carbohydrates are described in more detail herein below.

In another particular embodiment, the weight management agent is a dietary fat. Dietary fats are lipids comprising combinations of saturated and unsaturated fatty acids. Polyunsaturated fatty acids have been shown to have a greater satiating power than mono-unsaturated fatty acids. Accordingly, the dietary fats embodied herein desirably comprise polyunsaturated fatty acids, non-limiting examples of which include triacylglycerols.

In another particular embodiment, the weight management agent is an herbal extract. Extracts from numerous types of plants have been identified as possessing appetite suppressant properties. Non-limiting examples of plants whose extracts have appetite suppressant properties include plants of the genus Hoodia, Trichocaulon, Caralluma, Stapelia, Orbea, Asclepias, and Camelia. Other embodiments include extracts derived from Gymnema sylvestre, Kola nut, Citrus aurantium, Yerba mate, Griffonia simplicifolia, guarana, myrrh, guggul Lipid, and black current seed oil.

The herbal extracts may be prepared from any type of plant material or plant biomass. Non-limiting examples of plant material and biomass include the stems, roots, leaves, dried powder obtained from the plant material, and sap or dried sap. The herbal extracts generally are prepared by extracting sap from the plant and then spray-drying the sap. Alternatively, solvent extraction procedures may be employed. Following the initial extraction, it may be desirable to further fractionate the initial extract (e.g., by column chromatography) in order to obtain an herbal extract with enhanced activity. Such techniques are well known to those of ordinary skill in the art.

In one embodiment, the herbal extract is derived from a plant of the genus Hoodia. A sterol glycoside of Hoodia, known as P57, is believed to be responsible for the appetite-suppressant effect of the Hoodia species. In another embodiment, the herbal extract is derived from a plant of the genus Caralluma, non-limiting examples of which include caratuberside A, caratuberside B, bouceroside I, bouceroside II, bouceroside Ill, bouceroside IV, bouceroside V, bouceroside VI, bouceroside VII, bouceroside VIII, bouceroside IX, and bouceroside X. In another embodiment, the at least one herbal extract is derived from a plant of the genus Trichocaulon. Trichocaulon plants are succulents that generally are native to southern Africa, similar to Hoodia, and include the species T. piliferum and T. officinale. In another embodiment, the herbal extract is derived from a plant of the genus Stapelia or Orbea. Not wishing to be bound by any theory, it is believed that the compounds exhibiting appetite suppressant activity are saponins, such as pregnane glycosides, which include stavarosides A, B, C, D, E, F, G, H, I, J, and K. In another embodiment, the herbal extract is derived from a plant of the genus Asclepias. Not wishing to be bound by any theory, it is believed that the extracts comprise steroidal compounds, such as pregnane glycosides and pregnane aglycone, having appetite suppressant effects.

In another particular embodiment, the weight management agent is an exogenous hormone having a weight management effect. Non-limiting examples of such hormones include CCK, peptide YY, ghrelin, bombesin and gastrin-releasing peptide (GRP), enterostatin, apolipoprotein A-IV, GLP-1, amylin, somastatin, and leptin.

In another embodiment, the weight management agent is a pharmaceutical drug. Non-limiting examples include phentenime, diethylpropion, phendimetrazine, sibutramine, rimonabant, oxyntomodulin, floxetine hydrochloride, ephedrine, phenethylamine, or other stimulants.

In certain embodiments, the functional ingredient is at least one osteoporosis management agent. In certain embodiments, the osteoporosis management agent is at least one calcium source. According to a particular embodiment, the calcium source is any compound containing calcium, including salt complexes, solubilized species, and other forms of calcium. Non-limiting examples of calcium sources include amino acid chelated calcium, calcium carbonate, calcium oxide, calcium hydroxide, calcium sulfate, calcium chloride, calcium phosphate, calcium hydrogen phosphate, calcium dihydrogen phosphate, calcium citrate, calcium malate, calcium citrate malate, calcium gluconate, calcium tartrate, calcium lactate, solubilized species thereof, and combinations thereof.

According to a particular embodiment, the osteoporosis management agent is a magnesium source. The magnesium source is any compound containing magnesium, including salt complexes, solubilized species, and other forms of magnesium. Non-limiting examples of magnesium sources include magnesium chloride, magnesium citrate, magnesium gluceptate, magnesium gluconate, magnesium lactate, magnesium hydroxide, magnesium picolate, magnesium sulfate, solubilized species thereof, and mixtures thereof. In another particular embodiment, the magnesium source comprises an amino acid chelated or creatine chelated magnesium.

In other embodiments, the osteoporosis agent is chosen from vitamins D, C, K, their precursors and/or beta-carotene and combinations thereof.

Numerous plants and plant extracts also have been identified as being effective in the prevention and treatment of osteoporosis. Non-limiting examples of suitable plants and plant extracts as osteoporosis management agents include species of the genus Taraxacum and Amelanchier, as disclosed in U.S. Patent Publication No. 2005/0106215, and species of the genus Lindera, Artemisia, Acorus, Carthamus, Carum, Cnidium, Curcuma, Cyperus, Juniperus, Prunus, Iris, Cichorium, Dodonaea, Epimedium, Erigonoum, Soya, Mentha, Ocimum, thymus, Tanacetum, Plantago, Spearmint, Bixa, Vitis, Rosemarinus, Rhus, and Anethum, as disclosed in U.S. Patent Publication No. 2005/0079232.

In certain embodiments, the functional ingredient is at least one phytoestrogen. Phytoestrogens are compounds found in plants which can typically be delivered into human bodies by ingestion of the plants or the plant parts having the phytoestrogens. As used herein, “phytoestrogen” refers to any substance which, when introduced into a body causes an estrogen-like effect of any degree. For example, a phytoestrogen may bind to estrogen receptors within the body and have a small estrogen-like effect.

Examples of suitable phytoestrogens for embodiments of this invention include, but are not limited to, isoflavones, stilbenes, lignans, resorcyclic acid lactones, coumestans, coumestrol, equol, and combinations thereof. Sources of suitable phytoestrogens include, but are not limited to, whole grains, cereals, fibers, fruits, vegetables, black cohosh, agave root, black currant, black haw, chasteberries, cramp bark, dong quai root, devil's club root, false unicorn root, ginseng root, groundsel herb, licorice, liferoot herb, motherwort herb, peony root, raspberry leaves, rose family plants, sage leaves, sarsaparilla root, saw palmetto berried, wild yam root, yarrow blossoms, legumes, soybeans, soy products (e.g., miso, soy flour, soymilk, soy nuts, soy protein isolate, tempen, or tofu) chick peas, nuts, lentils, seeds, clover, red clover, dandelion leaves, dandelion roots, fenugreek seeds, green tea, hops, red wine, flaxseed, garlic, onions, linseed, borage, butterfly weed, caraway, chaste tree, vitex, dates, dill, fennel seed, gotu kola, milk thistle, pennyroyal, pomegranates, southernwood, soya flour, tansy, and root of the kudzu vine (Pueraria root) and the like, and combinations thereof.

Isoflavones belong to the group of phytonutrients called polyphenols. In general, polyphenols (also known as “polyphenolics”), are a group of chemical substances found in plants, characterized by the presence of more than one phenol group per molecule.

Suitable phytoestrogen isoflavones in accordance with embodiments of this invention include genistein, daidzein, glycitein, biochanin A, formononetin, their respective naturally occurring glycosides and glycoside conjugates, matairesinol, secoisolariciresinol, enterolactone, enterodiol, textured vegetable protein, and combinations thereof.

Suitable sources of isoflavones for embodiments of this invention include, but are not limited to, soy beans, soy products, legumes, alfalfa sprouts, chickpeas, peanuts, and red clover.

In certain embodiments, the functional ingredient is at least one long chain primary aliphatic saturated alcohol. Long-chain primary aliphatic saturated alcohols are a diverse group of organic compounds. The term alcohol refers to the fact these compounds feature a hydroxyl group (—OH) bound to a carbon atom. Non-limiting examples of particular long-chain primary aliphatic saturated alcohols for use in particular embodiments of the invention include the 8 carbon atom 1-octanol, the 9 carbon 1-nonanol, the 10 carbon atom 1-decanol, the 12 carbon atom 1-dodecanol, the 14 carbon atom 1-tetradecanol, the 16 carbon atom 1-hexadecanol, the 18 carbon atom 1-octadecanol, the 20 carbon atom I-eicosanol, the 22 carbon 1-docosanol, the 24 carbon 1-tetracosanol, the 26 carbon 1-hexacosanol, the 27 carbon 1-heptacosanol, the 28 carbon 1-octanosol, the 29 carbon 1-nonacosanol, the 30 carbon 1-triacontanol, the 32 carbon 1-dotriacontanol, and the 34 carbon 1-tetracontanol.

In one embodiment, the long-chain primary aliphatic saturated alcohol is a policosanol. Policosanol is the term for a mixture of long-chain primary aliphatic saturated alcohols composed primarily of 28 carbon 1-octanosol and 30 carbon 1-triacontanol, as well as other alcohols in lower concentrations such as 22 carbon 1-docosanol, 24 carbon 1-tetracosanol, 26 carbon 1-hexacosanol, 27 carbon 1-heptacosanol, 29 carbon 1-nonacosanol, 32 carbon 1-dotriacontanol, and 34 carbon 1-tetracontanol.

In certain embodiments, the functional ingredient is at least one phytosterol, phytostanol or combination thereof. As used herein, the phrases “stanol”, “plant stanol” and “phytostanol” are synonymous. Plant sterols and stanols are present naturally in small quantities in many fruits, vegetables, nuts, seeds, cereals, legumes, vegetable oils, bark of the trees and other plant sources. Sterols are a subgroup of steroids with a hydroxyl group at C-3. Generally, phytosterols have a double bond within the steroid nucleus, like cholesterol; however, phytosterols also may comprise a substituted side chain (R) at C-24, such as an ethyl or methyl group, or an additional double bond. The structures of phytosterols are well known to those of skill in the art.

At least 44 naturally-occurring phytosterols have been discovered, and generally are derived from plants, such as corn, soy, wheat, and wood oils; however, they also may be produced synthetically to form compositions identical to those in nature or having properties similar to those of naturally-occurring phytosterols. Non-limiting suitable phytosterols include, but are not limited to, 4-desmethylsterols (e.g., β-sitosterol, campesterol, stigmasterol, brassicasterol, 22-dehydrobrassicasterol, and Δ5-avenasterol), 4-monomethyl sterols, and 4,4-dimethyl sterols (triterpene alcohols) (e.g., cycloartenol, 24-methylenecycloartanol, and cyclobranol).

As used herein, the phrases “stanol”, “plant stanol” and “phytostanol” are synonymous. Phytostanols are saturated sterol alcohols present in only trace amounts in nature and also may be synthetically produced, such as by hydrogenation of phytosterols. Suitable phytostanols include, but are not limited to, β-sitostanol, campestanol, cycloartanol, and saturated forms of other triterpene alcohols.

Both phytosterols and phytostanols, as used herein, include the various isomers such as the α and β isomers. The phytosterols and phytostanols of the present invention also may be in their ester form. Suitable methods for deriving the esters of phytosterols and phytostanols are well known to those of ordinary skill in the art, and are disclosed in U.S. Pat. Nos. 6,589,588, 6,635,774, 6,800,317, and U.S. Patent Publication Number 2003/0045473. Non-limiting examples of suitable phytosterol and phytostanol esters include sitosterol acetate, sitosterol oleate, stigmasterol oleate, and their corresponding phytostanol esters. The phytosterols and phytostanols of the present invention also may include their derivatives.

The beverages described herein can further include at least one additive. Exemplary additives include, but not limited to, carbohydrates, polyols, amino acids and their corresponding salts, poly-amino acids and their corresponding salts, sugar acids and their corresponding salts, nucleotides, organic acids, inorganic acids, bitter compounds, caffeine, flavorants and flavoring ingredients, astringent compounds, proteins or protein hydrolysates, surfactants, emulsifiers, plant extracts, flavonoids, alcohols, polymers and combinations thereof.

The term “polyol”, as used herein, refers to a molecule that contains more than one hydroxyl group. A polyol may be a diol, triol, or a tetraol which contains 2, 3, and 4 hydroxyl groups respectively. A polyol also may contain more than 4 hydroxyl groups, such as a pentaol, hexaol, heptaol, or the like, which contain 5, 6, or 7 hydroxyl groups, respectively. Additionally, a polyol also may be a sugar alcohol, polyhydric alcohol, or polyalcohol which is a reduced form of carbohydrate, wherein the carbonyl group (aldehyde or ketone, reducing sugar) has been reduced to a primary or secondary hydroxyl group. Non-limiting examples of polyols in some embodiments include maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, and sugar alcohols or any other carbohydrates capable of being reduced which do not adversely affect taste.

Suitable amino acid additives include, but are not limited to, aspartic acid, arginine, glycine, glutamic acid, proline, threonine, theanine, cysteine, cystine, alanine, valine, tyrosine, leucine, arabinose, trans-4-hydroxyproline, isoleucine, asparagine, serine, lysine, histidine, ornithine, methionine, carnitine, aminobutyric acid (α-, β-, and/or δ-isomers), glutamine, hydroxyproline, taurine, norvaline, sarcosine, and their salt forms such as sodium or potassium salts or acid salts. The amino acid additives also may be in the D- or L-configuration and in the mono-, di-, or tri-form of the same or different amino acids. Additionally, the amino acids may be α-, β-, γ- and/or δ-isomers if appropriate. Combinations of the foregoing amino acids and their corresponding salts (e.g., sodium, potassium, calcium, magnesium salts or other alkali or alkaline earth metal salts thereof, or acid salts) also are suitable additives in some embodiments. The amino acids may be natural or synthetic. The amino acids also may be modified. Modified amino acids refers to any amino acid wherein at least one atom has been added, removed, substituted, or combinations thereof (e.g., N-alkyl amino acid, N-acyl amino acid, or N-methyl amino acid). Non-limiting examples of modified amino acids include amino acid derivatives such as trimethyl glycine, N-methyl-glycine, and N-methyl-alanine. As used herein, modified amino acids encompass both modified and unmodified amino acids. As used herein, amino acids also encompass both peptides and polypeptides (e.g., dipeptides, tripeptides, tetrapeptides, and pentapeptides) such as glutathione and L-alanyl-L-glutamine.

Suitable polyamino acid additives include poly-L-aspartic acid, poly-L-lysine (e.g., poly-L-α-lysine or poly-L-ε-lysine), poly-L-ornithine (e.g., poly-L-α-ornithine or poly-L-ε-ornithine), poly-L-arginine, other polymeric forms of amino acids, and salt forms thereof (e.g., calcium, potassium, sodium, or magnesium salts such as L-glutamic acid mono sodium salt). The poly-amino acid additives also may be in the D- or L-configuration. Additionally, the poly-amino acids may be α-, β-, γ-, δ-, and ε-isomers if appropriate. Combinations of the foregoing poly-amino acids and their corresponding salts (e.g., sodium, potassium, calcium, magnesium salts or other alkali or alkaline earth metal salts thereof or acid salts) also are suitable additives in some embodiments. The poly-amino acids described herein also may comprise co-polymers of different amino acids. The poly-amino acids may be natural or synthetic. The poly-amino acids also may be modified, such that at least one atom has been added, removed, substituted, or combinations thereof (e.g., N-alkyl poly-amino acid or N-acyl poly-amino acid). As used herein, poly-amino acids encompass both modified and unmodified poly-amino acids. For example, modified poly-amino acids include, but are not limited to, poly-amino acids of various molecular weights (MW), such as poly-L-α-lysine with a MW of 1,500, MW of 6,000, MW of 25,200, MW of 63,000, MW of 83,000, or MW of 300,000.

Suitable sugar acid additives include, but are not limited to, aldonic, uronic, aldaric, alginic, gluconic, glucuronic, glucaric, galactaric, galacturonic, and salts thereof (e.g., sodium, potassium, calcium, magnesium salts or other physiologically acceptable salts), and combinations thereof.

Suitable nucleotide additives include, but are not limited to, inosine monophosphate (“IMP”), guanosine monophosphate (“GMP”), adenosine monophosphate (“AMP”), cytosine monophosphate (CMP), uracil monophosphate (UMP), inosine diphosphate, guanosine diphosphate, adenosine diphosphate, cytosine diphosphate, uracil diphosphate, inosine triphosphate, guanosine triphosphate, adenosine triphosphate, cytosine triphosphate, uracil triphosphate, alkali or alkaline earth metal salts thereof, and combinations thereof. The nucleotides described herein also may comprise nucleotide-related additives, such as nucleosides or nucleic acid bases (e.g., guanine, cytosine, adenine, thymine, uracil).

Suitable organic acid additives include any compound which comprises a —COOH moiety, such as, for example, C2-C30 carboxylic acids, substituted hydroxyl C2-C30 carboxylic acids, butyric acid (ethyl esters), substituted butyric acid (ethyl esters), benzoic acid, substituted benzoic acids (e.g., 2,4-dihydroxybenzoic acid), substituted cinnamic acids, hydroxyacids, substituted hydroxybenzoic acids, anisic acid substituted cyclohexyl carboxylic acids, tannic acid, aconitic acid, lactic acid, tartaric acid, citric acid, isocitric acid, gluconic acid, glucoheptonic acids, adipic acid, hydroxycitric acid, malic acid, fruitaric acid (a blend of malic, fumaric, and tartaric acids), fumaric acid, maleic acid, succinic acid, chlorogenic acid, salicylic acid, creatine, caffeic acid, bile acids, acetic acid, ascorbic acid, alginic acid, erythorbic acid, polyglutamic acid, glucono delta lactone, and their alkali or alkaline earth metal salt derivatives thereof. In addition, the organic acid additives also may be in either the D- or L-configuration.

Suitable bitter compound additives include, but are not limited to, caffeine, quinine, urea, bitter orange oil, naringin, quassia, and salts thereof.

Suitable flavorants and flavoring ingredient additives include, but are not limited to, vanillin, vanilla extract, mango extract, cinnamon, citrus, coconut, ginger, viridiflorol, almond, menthol (including menthol without mint), grape skin extract, and grape seed extract. “Flavorant” and “flavoring ingredient” are synonymous and can include natural or synthetic substances or combinations thereof. Flavorants also include any other substance which imparts flavor and may include natural or non-natural (synthetic) substances which are safe for human or animals when used in a generally accepted range. Non-limiting examples of proprietary flavorants include Döhler™ Natural Flavoring Sweetness Enhancer K14323 (Döhler™, Darmstadt, Germany), Symrise™ Natural Flavor Mask for Sweeteners 161453 and 164126 (Symrise™, Holzminden, Germany), Natural Advantage™ Bitterness Blockers 1, 2, 9 and 10 (Natural Advantage™, Freehold, New Jersey, U.S.A.), and Sucramask™ (Creative Research Management, Stockton, California, U.S.A.).

Suitable polymer additives include, but are not limited to, chitosan, pectin, pectic, pectinic, polyuronic, polygalacturonic acid, starch, food hydrocolloid or crude extracts thereof (e.g., gum acacia senegal (Fibergum™), gum acacia seyal, carageenan), poly-L-lysine (e.g., poly-L-α-lysine or poly-L-ε-lysine), poly-L-ornithine (e.g., poly-L-α-ornithine or poly-L-ε-ornithine), polypropylene glycol, polyethylene glycol, poly(ethylene glycol methyl ether), polyarginine, polyaspartic acid, polyglutamic acid, polyethylene imine, alginic acid, sodium alginate, propylene glycol alginate, and sodium polyethyleneglycolalginate, sodium hexametaphosphate and its salts, and other cationic polymers and anionic polymers.

Suitable protein or protein hydrolysate additives include, but are not limited to, bovine serum albumin (BSA), whey protein (including fractions or concentrates thereof such as 90% instant whey protein isolate, 34% whey protein, 50% hydrolyzed whey protein, and 80% whey protein concentrate), soluble rice protein, soy protein, protein isolates, protein hydrolysates, reaction products of protein hydrolysates, glycoproteins, and/or proteoglycans containing amino acids (e.g., glycine, alanine, serine, threonine, asparagine, glutamine, arginine, valine, isoleucine, leucine, norvaline, methionine, proline, tyrosine, hydroxyproline, and the like), collagen (e.g., gelatin), partially hydrolyzed collagen (e.g., hydrolyzed fish collagen), and collagen hydrolysates (e.g., porcine collagen hydrolysate).

Suitable surfactant additives include, but are not limited to, polysorbates (e.g., polyoxyethylene sorbitan monooleate (polysorbate 80), polysorbate 20, polysorbate 60), sodium dodecylbenzenesulfonate, dioctyl sulfosuccinate or dioctyl sulfosuccinate sodium, sodium dodecyl sulfate, cetylpyridinium chloride (hexadecylpyridinium chloride), hexadecyltrimethylammonium bromide, sodium cholate, carbamoyl, choline chloride, sodium glycocholate, sodium taurodeoxycholate, lauric arginate, sodium stearoyl lactylate, sodium taurocholate, lecithins, sucrose oleate esters, sucrose stearate esters, sucrose palmitate esters, sucrose laurate esters, and other emulsifiers, and the like.

Suitable flavonoid additives are classified as flavonols, flavones, flavanones, flavan-3-ols, isoflavones, or anthocyanidins. Non-limiting examples of flavonoid additives include, but are not limited to, catechins (e.g., green tea extracts such as Polyphenon™ 60, Polyphenon™ 30, and Polyphenon™ 25 (Mitsui Norin Co., Ltd., Japan), polyphenols, rutins (e.g., enzyme modified rutin Sanmelin™ AO (San-fi Gen F.F.I., Inc., Osaka, Japan)), neohesperidin, naringin, neohesperidin dihydrochalcone, and the like. In certain embodiments, the beverage comprises a dihydrochalcone compounds, such as hesperetin dihydrochalcone, phloretin, neohesperidin dihydrochalcone, hesperetin dihydrochalcone-4′-β-D-glucoside, or a combination thereof.

Suitable alcohol additives include, but are not limited to, ethanol.

Suitable astringent compound additives include, but are not limited to, tannic acid, europium chloride (EuCl₃), gadolinium chloride (GdCl₃), terbium chloride (TbCl₃), alum, tannic acid, and polyphenols (e.g., tea polyphenols).

### Beverage Products

“Beverage product”, as used herein, is a ready-to-drink beverage, a beverage concentrate, a beverage syrup, or a powdered beverage. Suitable ready-to-drink beverages include carbonated and non-carbonated beverages. Carbonated beverages include, but are not limited to, frozen carbonated beverages, enhanced sparkling beverages, cola, fruit-flavored sparkling beverages (e.g. lemon-lime, orange, grape, strawberry and pineapple), ginger-ale, soft drinks and root beer. Non-carbonated beverages include, but are not limited to, fruit juice, fruit-flavored juice, juice drinks, nectars, vegetable juice, vegetable-flavored juice, sports drinks, energy drinks, enhanced water drinks, enhanced water with vitamins, near water drinks (e.g., water with natural or synthetic flavorants), coconut water, tea type drinks (e.g. black tea, green tea, red tea, oolong tea), coffee, cocoa drink, beverage containing milk components (e.g. milk beverages, coffee containing milk components, café au lait, milk tea, fruit milk beverages), beverages containing cereal extracts and smoothies.

In another aspect, a beverage product, e.g., a syrup or concentrate, comprising a mogroside blend sweetener according to any of the foregoing embodiments is provided. The concentrate or syrup comprising the mogroside blend sweetener can be used as a dispensable liquid sweetener.

Beverage concentrates and beverage syrups are prepared with an initial volume of liquid matrix (e.g. water) and the desired beverage ingredients. Full strength beverages are then prepared by adding further volumes of water. Powdered beverages are prepared by dry-mixing all of the beverage ingredients in the absence of a liquid matrix. Full strength beverages are then prepared by adding the full volume of water.

The beverage product can optionally include additives, functional ingredients and combinations thereof, as described herein.

The beverage product comprises the mogroside blend is formulated to deliver a beverage comprising the mogroside blend in the weight percentages or concentrations as described herein when combined with the liquid matrix

### III. Methods

In another aspect, methods of preparing the beverages of the present invention are also provided.

In one embodiment, a method of preparing a beverage comprises (i) providing a beverage matrix (ii) adding at least one mogroside blend described herein in a sweetening amount, thereby providing a sweetened beverage. The method can further comprise adding at least one functional ingredient and/or at least one additive described hereinabove.

### EXAMPLES

### Example 1

Compounds having >95% purity were used to prepare the beverages. Substances were added into filtered water while stirring. The solution was stirred visibly clear and the sample was poured into a glass bottle or vial and stored at 4° C. The sample was tested within 24 hours at room temperature.

Taste tests were carried out with 7-9 panelists and run singlet to triplet. Bottles were removed from the refrigerator and about 10 ml of beverage was poured into 4 oz-plastic cups. Panelists were given mineral water to rinse their mouths before tasting and between tasting different sets. Panelists were also given unsalted crackers to eat and rinsed their mouths with mineral water before tasting the next set of samples. In each set, panelists tasted the samples, held the samples in their mouths for 5 seconds, expectorated, and then measured bitterness for about 30 seconds before tasting the next sample. The panelists then selected the more bitter sample between the two samples in each set.

TABLE 1
Bitterness reduction using Mogroside Blend

| | | | Number of | Number of |
|---|---|---|---|---|
| | | | Panelists | Panelists |
| | Concentration of | Concentration of | that chose | that chose |
| | mogroside in | mogroside in | A as more | B as more |
| | Sample A | Sample B | bitter | bitter |
| 1 | 400 ppm of | 320 ppm of | 15 | 6 |
| | Siamenoside | Siamenoside I and 80 | | |
| | | ppm (20 wt %) of 11- | | |
| | | oxomogroside V | | |

TABLE 2
Bitterness Threshold on Mogroside Blend

| | | | Number of | Number of |
|---|---|---|---|---|
| | | | Panelists | Panelists |
| | Concentration of | Concentration of | that chose | that chose |
| | mogroside in | mogroside in | A as more | B as more |
| | Sample A | Sample B | bitter | bitter |
| 1 | 400 ppm of | 360 ppm of | 6 | 15^{#} |
| | Siamenoside I | Siamenoside I and 40 | | |
| | | ppm (10 wt %) of | | |
| | | mogroside IVA | | |
| 2 | 500 ppm of | 450 ppm of | 2 | 13 |
| | Siamenoside I | Siamenoside I and 50 | | |
| | | ppm (10 wt %) of | | |
| | | mogroside III | | |
| 3 | 500 ppm of | 487.5 ppm of | 2 | 14 |
| | Siamenoside I | Siamenoside I and | | |
| | | 12.5 ppm (2.5 wt %) of | | |
| | | mogroside IIA2 | | |
| 4 | 500 ppm of | 495 ppm of | 0 | 2* |
| | Siamenoside I | Siamenoside I and 5 | | |
| | | ppm (1 wt %) of | | |
| | | mogroside IA (CC- | | |
| | | 00368) | | |
| 5 | 500 ppm of | 495 ppm of | 0 | 2* |
| | Siamenoside I | Siamenoside I and 5 | | |
| | | ppm (1 wt %) of | | |
| | | mogroside IE | | |

^{#}Six reports about high bitterness
*Due to sample availability, two panels tested the samples.

TABLE 3
Negligible bitterness difference in mogroside blend

| | | | Number of | Number of |
|---|---|---|---|---|
| | Concentration of | Concentration of | Panelists that | Panelists that |
| | mogroside in | mogroside | chose A as | chose B as |
| | Sample A | in Sample B | more bitter | more bitter |
| 1 | 400 ppm of | 320 ppm of | 10 | 11 |
| | Siamenoside I | Siamenoside I | | |
| | | and 80 ppm | | |
| | | (20 wt %) of | | |
| | | mogroside IIIE | | |
| 2 | 400 ppm of | 320 ppm of | 10 | 10 |
| | Siamenoside I | Siamenoside I | | |
| | | and 80 ppm | | |
| | | (20 wt %) of 11- | | |
| | | oxosiamenoside I | | |
| 3 | 500 ppm of | 487.5 ppm of | 7 | 8 |
| | Siamenoside I | Siamenoside I | | |
| | | and 12.5 ppm | | |
| | | (2.5 wt %) of | | |
| | | mogroside IIA1 | | |
| 4 | 500 ppm of | 400 ppm of | 7 | 8 |
| | Siamenoside I | Siamenoside I | | |
| | | and 100 ppm | | |
| | | (20 wt %) of 11- | | |
| | | oxomogroside IIIE | | |
| 5 | 500 ppm of | 450 ppm of | 7 | 6 |
| | Siamenoside I | Siamenoside I | | |
| | | and 50 ppm | | |
| | | (10 wt %) of | | |
| | | mogroside IIIA2 | | |
| 1 | 400 ppm of | 320 ppm of | 10 | 11 |
| | Siamenoside I | Siamenoside I | | |
| | | and 80 ppm | | |
| | | (20 wt %) of | | |
| | | mogroside IIIE | | |
| 2 | 400 ppm of | 320 ppm of | 10 | 10 |
| | Siamenoside I | Siamenoside I | | |
| | | and 80 ppm | | |
| | | (20 wt %) of 11- | | |
| | | oxosiamenoside I | | |
| 3 | 500 ppm of | 487.5 ppm of | 7 | 8 |
| | Siamenoside I | Siamenoside I | | |
| | | and 12.5 ppm | | |
| | | (2.5 wt %) of | | |
| | | mogroside IIA1 | | |
| 4 | 500 ppm of | 400 ppm of | 7 | 8 |
| | Siamenoside I | Siamenoside I | | |
| | | and 100 ppm | | |
| | | (20 wt %) of 11- | | |
| | | oxomogroside IIIE | | |
| 5 | 500 ppm of | 450 ppm of | 7 | 6 |
| | Siamenoside I | Siamenoside I | | |
| | | and 50 ppm | | |
| | | (10 wt %) of | | |
| | | mogroside IIIA2 | | |

Blend of mogrosides with 20 wt % of 11-oxomogroside V were generally perceived as less bitter than siamenoside I alone in 400~500 ppm of total mogroside.

10 wt % of mogroside IVA or mogroside III, 2.5 wt % of mogroside IIA2, and 1 wt % of mogroside IA or mogroside IE increased the perception of bitterness.

20 wt % of mogroside IIIE or 11-oxomogroside IIIE or 11-oxosiamenoside I, 10 wt % of mogroside IIIA2, and 2.5 wt % of mogroside IIA1 did not impact bitterness of the beverage.

### Example 2

Compounds having >95% purity were used to prepare the beverages. Substances were added into filtered water while stirring. The solution was stirred until visibly clear, and the sample was poured into a glass bottle or vial and stored at 4° C.

Sensory tests were carried out with 9-10 panelists and run singlet to triplet. Bottles were removed from the refrigerator and about 10 ml of beverage was poured into 4 oz-plastic cups. Panelists were given mineral water to rinse their mouth before tasting and between tasting different sets. Panelists were also given unsalted crackers to eat and rinsed their mouths with mineral water before tasting the next set of samples. In each set, panelists tasted the samples, held the samples in their mouths for 5 seconds, expectorated, and then measured bitterness for about 30 seconds before tasting the next sample. The panelists then selected the more bitter sample between the two samples in each set.

TABLE 4
Bitterness reduction using mogroside blend

| | | | Number of | Number of |
|---|---|---|---|---|
| | Concentration of | Concentration of | Panelists that | Panelists that |
| | mogroside in | mogroside in | chose A as | chose B as |
| | Sample A | Sample B | more bitter | more bitter |
| 1 | 500 ppm of | 400 ppm of | 17 | 8 |
| | Siamenoside I | Siamenoside I | | |
| | | and 100 ppm | | |
| | | (20 wt %) | | |
| | | of Isomogroside V | | |
| 2 | 500 ppm of | 450 ppm of | 16 | 11 |
| | Siamenoside I | Siamenoside I | | |
| | | and 50 ppm | | |
| | | (10 wt %) of 11- | | |
| | | Oxomogroside V | | |
| 3 | 500 ppm of | 400 ppm of | 23 | 7 |
| | Siamenoside I | Siamenoside I | | |
| | | and 100 ppm | | |
| | | (20 wt %) of 11- | | |
| | | Oxomogroside V | | |
| 4 | 500 ppm of | 487.5 ppm of | 16 | 12 |
| | Siamenoside I | Siamenoside I | | |
| | | and 12.5 ppm | | |
| | | (2.5 wt %) of 11- | | |
| | | Oxomogroside III | | |
| 5 | 500 ppm of | 487.5 ppm of | 19 | 11 |
| | Siamenoside I | Siamenoside I | | |
| | | and 12.5 ppm | | |
| | | (2.5 wt %) of | | |
| | | Mogroside III | | |
| 6 | 500 ppm of | 475 ppm of | 15 | 11 |
| | Siamenoside I | Siamenoside I | | |
| | | and 25 ppm | | |
| | | (5 wt %) of 11- | | |
| | | oxoisomogroside V | | |
| 7 | 500 ppm of | 487.5 ppm of | 17 | 13 |
| | Siamenoside I | Siamenoside I | | |
| | | and 12.5 ppm | | |
| | | (2.5 wt %) of | | |
| | | mogroside IIE | | |

TABLE 5
Bitterness Threshold in Mogroside Blend

| | | | Number of | Number of |
|---|---|---|---|---|
| | Concentration of | Concentration of | Panelists that | Panelists that |
| | mogroside in | mogroside in | chose A as | chose B as |
| | Sample A | Sample B | more bitter | more bitter |
| 1 | 500 ppm of | 495 ppm of | 8 | 20 |
| | Siamenoside I | Siamenoside I | | |
| | | and 5 ppm | | |
| | | (1 wt %) of 11- | | |
| | | Oxomogroside IIA2 | | |
| 2 | 500 ppm of | 495 ppm of | 10 | 19 |
| | Siamenoside I | Siamenoside I | | |
| | | and 5 ppm | | |
| | | (1 wt %) of 11- | | |
| | | Oxomogroside IIA1 | | |
| 3 | 500 ppm of | 400 ppm of | 8 | 22 |
| | Siamenoside I | Siamenoside I | | |
| | | and 100 ppm | | |
| | | (20 wt %) of | | |
| | | mogroside IIA | | |
| 4 | 500 ppm of | 450 ppm of | 7 | 23 |
| | Siamenoside I | Siamenoside I | | |
| | | and 50 ppm | | |
| | | (10 wt %) of 11- | | |
| | | Oxomogroside IIA | | |
| 5 | 500 ppm of | 400 ppm of | 7 | 19 |
| | Siamenoside I | Siamenoside I | | |
| | | and 100 ppm | | |
| | | (20 wt %) of | | |
| | | mogroside IIIA2 | | |
| 6 | 500 ppm of | 450 ppm of | 6 | 20 |
| | Siamenoside I | Siamenoside I | | |
| | | and 50 ppm | | |
| | | (10 wt %) of | | |
| | | mogroside IVA | | |
| 7 | 500 ppm of | 475 ppm of | 10 | 16 |
| | Siamenoside I | Siamenoside I | | |
| | | and 25 ppm | | |
| | | (5 wt %) of | | |
| | | mogroside IIA1 | | |
| 8 | 500 ppm of | 475 ppm of | 10 | 15 |
| | Siamenoside I | Siamenoside I | | |
| | | and 25 ppm | | |
| | | (5 wt %) of 11- | | |
| | | oxomogroside III | | |
| | 500 ppm of | 400 ppm of | 12 | 18 |
| | Siamenoside I | Siamenoside I | | |
| | | and 100 ppm | | |
| | | (20 wt %) of 11- | | |
| | | oxomogroside IIE | | |

TABLE 6
Negligible bitterness difference in mogroside blend

| | | | Number of | Number of |
|---|---|---|---|---|
| | Concentration of | Concentration of | Panelists that | Panelists that |
| | mogroside in | mogroside in | chose A as | chose B as |
| | Sample A | Sample B | more bitter | more bitter |
| 1 | 500 ppm of | 475 ppm of | 15 | 15 |
| | Siamenoside I | Siamenoside I | | |
| | | and 25 ppm | | |
| | | (5 wt %) of | | |
| | | mogroside IVA | | |
| 2 | 500 ppm of | 450 ppm of | 15 | 14 |
| | Siamenoside I | Siamenoside I | | |
| | | and 50 ppm | | |
| | | (10 wt %) of 11- | | |
| | | oxomogroside IIE | | |
| 3 | 500 ppm of | 400 ppm of | 12 | 12 |
| | Siamenoside I | Siamenoside I | | |
| | | and 100 ppm | | |
| | | (20 wt %) of | | |
| | | mogroside V | | |
| 4 | 500 ppm of | 487.5 ppm of | 13 | 13 |
| | Siamenoside I | Siamenoside I | | |
| | | and 12.5 ppm | | |
| | | (2.5 wt %) of 11- | | |
| | | oxomogroside IIA | | |
| 5 | 400 ppm of | 280 ppm of | 17 | 16 |
| | Siamenoside I | Siamenoside I | | |
| | | and 120 ppm | | |
| | | (30 wt %) of | | |
| | | mogroside V | | |

TABLE 7
Licorice flavor Reduction in Mogroside Blend

| | | | Number of | Number of |
|---|---|---|---|---|
| | | | Panelist | Panelists |
| | | | that | that |
| | | | chose A | chose B |
| | Concentration of | Concentration of | as higher | as higher |
| | mogroside in | mogroside in | licorice | licorice |
| | Sample A | Sample B | flavor | flavor |
| 1 | 400 ppm of | 360 ppm of | 20 | 13 |
| | Siamenoside I | Siamenoside I and 40 | | |
| | | ppm (10 wt %) of | | |
| | | isomogroside V | | |

TABLE 8
Mouthfeel Astringency Reduction in Mogroside Blend

| | | | Number of | Number of |
|---|---|---|---|---|
| | | | Panelists | Panelists |
| | | | that | that |
| | | | chose A as | chose B as |
| | Concentration of | Concentration of | higher | higher |
| | mogroside in | mogroside in | astringency | astringency |
| | Sample A | Sample B | flavor | flavor |
| 1 | 400 ppm of | 360 ppm of | 21 | 12 |
| | Siamenoside I | Siamenoside I | | |
| | | and 40 ppm | | |
| | | (10 wt %) of | | |
| | | isomogroside V | | |
| 2 | 400 ppm of | 360 ppm of | 20 | 13 |
| | Siamenoside I | Siamenoside I | | |
| | | and 40 ppm | | |
| | | (10 wt %) of | | |
| | | mogroside V | | |
| 3 | 400 ppm of | 360 ppm of | 22 | 11 |
| | Siamenoside I | Siamenoside I | | |
| | | and 40 ppm | | |
| | | (10 wt %) of | | |
| | | mogroside IIIE | | |

Blends of mogrosides with 20 wt % of isomogroside V, 10-20 wt % of 11-oxomogroside V, 2.5 wt % of 11-oxomogroside III or mogroside III, or 5 wt % of 11-oxoisomogroside V were perceived as less bitter than siamenoside I alone in 500 ppm of total mogroside. A blend of mogrosides can be used to reduce the bitterness as sweetener in beverage.

20 wt % of mogroside IIA or mogroside IIE or mogroside IIIA2, 10 wt % of 11-oxomogroside IIA or Mogroside IVA, 5 wt % of Mogroside IIA1 or 11-oxomogroside III, and 1 wt % of Mogroside IIA2 or 11-oxomogroside IIA1 increased the perception of bitterness in the beverage with mogroside as sweetener in 500 ppm of total mogroside.

A blend of mogrosides with 10 wt % of isomogroside V is generally perceived as having less intense licorice flavor as compared to siamenoside I alone in a beverage 400 ppm of total mogroside.

A blend of mogrosides with 10 wt % of isomogroside V or mogroside V or mogroside IIIE is generally perceived as less astringent than siamenoside I alone in a beverage at 400 ppm of total mogroside.

20-30 wt % of Mogroside V, 10 wt % of 1-Oxomogroside IIE, 5 wt % of Mogroside IVA, and 2.5 wt % of 11-Oxomogroside IIA did not impact the bitterness of the beverage with mogroside as sweetener in 400~500 ppm of total mogroside.

TABLE 9
Sweet (Sweetness) On-set in Mogroside Blend

| | | | Number of | Number of |
|---|---|---|---|---|
| | | | Panelist to | Panelist to |
| | Concentration of | Concentration of | choose A as | choose B as |
| | mogroside in | mogroside in | faster sweet | faster sweet |
| | Sample A | Sample B | on-set | on-set |
| 1 | 400 ppm of | 380 ppm of | 9 | 21 |
| | Siamenoside I | Siamenoside I | | |
| | | and 20 ppm | | |
| | | (5 wt %) of | | |
| | | mogroside V | | |
| 2 | 400 ppm of | 320 ppm of | 8 | 16 |
| | Siamenoside I | Siamenoside I | | |
| | | and 80 ppm | | |
| | | (20 wt %) of | | |
| | | mogroside V | | |
| 3 | 400 ppm of | 360 ppm of | 8 | 16 |
| | Siamenoside I | Siamenoside I | | |
| | | and 80 ppm | | |
| | | (20 wt %) of | | |
| | | mogroside IIIE | | |

TABLE 10
Syrupy Mouthfeel in Mogroside Blend

| | | | Number of | Number of |
|---|---|---|---|---|
| | | | Panelist to | Panelist to |
| | | | choose A as | choose B as |
| | Concentration of | Concentration of | higher | higher |
| | mogroside in | mogroside in | syrupy | syrupy |
| | Sample A | Sample B | mouthfeel | mouthfeel |
| 1 | 400 ppm of | 320 ppm of | 7 | 17 |
| | Siamenoside I | Siamenoside I | | |
| | | and 80 ppm | | |
| | | (20 wt %) of | | |
| | | mogroside IIIE | | |

A blend of mogrosides with 5~20 wt % of mogroside V or 20 wt % of mogroside IIIE is generally perceived as having faster sweet onset as compared to siamenoside I alone in a beverage 400 ppm of total mogroside. A blend of mogrosides can improve the sweet onset of beverage as compared to Siamenoside I individually in a beverage.

A blend of mogrosides with 20 wt % of mogroside IIIE is generally perceived as having more syrupy mouthfeel as compared to siamenoside I alone in a beverage 400 ppm of total mogroside. A blend of mogrosides can improve the syrupy mouthfeel of beverage as compared to Siamenoside I individually in a beverage.

### Example 3

Compounds having >95% purity were used to prepare the beverages. Substances were added into filtered water while stirring. The solution was stirred until visibly clear, and the sample was poured into a glass bottle or vial and stored at 4° C. Samples were tested within 7 days.

Sensory tests were carried out with 8-12 panelists. Each pair of mogroside blends was evaluated by each panelist in triplet. Bottles were removed from the refrigerator and about 10 ml of each beverage was poured into 4 oz-plastic cups. Panelists were given mineral water to rinse their mouth before tasting and between evaluating the different pairs. Panelists were also given unsalted crackers to eat and rinsed their mouths with mineral water before evaluating the next set of samples. In each set, panelists tasted a sample, held the sample in their mouths for 5 seconds, expectorated, and then measured bitterness for about 30 seconds before tasting the next sample. The panelists then chose the more bitter sample between the two samples in each set.

TABLE 11
Bitterness reduction using Mogroside Blend

| | | | Number of | Number of |
|---|---|---|---|---|
| | | | Panelist to | Panelist to |
| | Concentration of | Concentration of | choose | choose |
| | mogroside in | mogroside in | A as more | B as more |
| | Sample A | Sample B | bitter | bitter |
| 1 | 500 ppm of | 400 ppm of Siamenoside | 19 | 14 |
| | Siamenoside I | 1, 50 ppm (10 wt %) of | | |
| | | mogroside V, and 50 | | |
| | | ppm (10 wt %) of | | |
| | | mogroside IIIE | | |

TABLE 12
Bitterness Threshold in Mogroside Blend

| | | | Number of | Number of |
|---|---|---|---|---|
| | | | Panelist to | Panelist to |
| | Concentration of | Concentration of | choose | choose |
| | mogroside in | mogroside in | A as more | B as more |
| | Sample A | Sample B | bitter | bitter |
| 1 | 500 ppm of | 400 ppm of | 12 | 21 |
| | Siamenoside I | Siamenoside | | |
| | | I and 100 ppm | | |
| | | (20 wt %) of | | |
| | | mogroside IIIE | | |
| 2 | 500 ppm of | 450 ppm of | 11 | 18 |
| | Siamenoside I | Siamenoside | | |
| | | I and 50 ppm | | |
| | | (10 wt %) of | | |
| | | isomogroside V | | |
| 3 | 500 ppm of | 450 ppm of | 9 | 19 |
| | Siamenoside I | Siamenoside | | |
| | | I and 50 ppm | | |
| | | (10 wt %) of | | |
| | | mogroside IIIE | | |

TABLE 13
Negligible bitterness difference in Mogroside Blend

| | | | Number of | Number of |
|---|---|---|---|---|
| | | | Panelist to | Panelist to |
| | Concentration of | Concentration of | choose | choose |
| | mogroside in | mogroside in | A as more | B as more |
| | Sample A | Sample B | bitter | bitter |
| 1 | 500 ppm of | 400 ppm of | 16 | 17 |
| | Siamenoside I | Siamenoside I and 100 | | |
| | | ppm (20 wt %) of | | |
| | | mogroside V | | |
| 2 | 500 ppm of | 350 ppm of | 16 | 15 |
| | Siamenoside I | Siamenoside I and 150 | | |
| | | ppm (30 wt %) of | | |
| | | mogroside V | | |

TABLE 14
Licorice flavor Reduction in Mogroside Blend

| | | | Number of | Number of |
|---|---|---|---|---|
| | | | Panelist to | Panelist to |
| | | | choose | choose |
| | | | A as | B as |
| | Concentration of | Concentration of | higher | higher |
| | mogroside in | mogroside in | licorice | licorice |
| | Sample A | Sample B | flavor | flavor |
| 1 | 500 ppm of | 400 ppm of | 23 | 12 |
| | Siamenoside I | Siamenoside 1, 50 ppm | | |
| | | (10 wt %) of mogroside | | |
| | | V, and 50 ppm (10 | | |
| | | wt %) of mogroside IIIE | | |
| 2 | 500 ppm of | 450 ppm of | 23 | 13 |
| | Siamenoside I | Siamenoside 1, 25 ppm | | |
| | | (5 wt %) of mogroside | | |
| | | V, and 25 ppm (5 wt %) | | |
| | | of mogroside IIIE | | |

TABLE 15
Mouthfeel Astringency Reduction in Mogroside Blend

| | | | Number of | Number of |
|---|---|---|---|---|
| | | | Panelist to | Panelist to |
| | | | choose | choose |
| | | | A as | B as |
| | Concentration of | Concentration of | higher | higher |
| | mogroside in | mogroside in | licorice | licorice |
| | Sample A | Sample B | flavor | flavor |
| 1 | 500 ppm of | 400 ppm of | 20 | 13 |
| | Siamenoside I | Siamenoside I and 100 | | |
| | | ppm (20 wt %) of | | |
| | | mogroside V | | |
| 2 | 500 ppm of | 450 ppm of | 23 | 10 |
| | Siamenoside I | Siamenoside I and 50 | | |
| | | ppm (10 wt %) of | | |
| | | mogroside IIIE | | |

Tri-blend of mogrosides with 10 wt % of mogroside V and 10 wt % of mogroside IIIE is generally perceived as less bitter than siamenoside I alone in 500 ppm of total mogroside. A blend of mogrosides can be used to reduce the bitterness as sweetener in beverage.

10~20 wt % of mogroside III or 10 wt % of isomogroside V appears to increase the perception of bitterness in the beverage with mogroside as sweetener in 500 ppm of total mogroside.

20~30 wt % of Mogroside V does not impact the bitterness of the beverage with mogroside as sweetener in 500 ppm of total mogroside.

Tri-blend of mogrosides with 5~10 wt % of mogroside V and 5~10 wt % of mogroside IIIE is perceived as having less intense licorice flavor as compared to siamenoside I alone in a beverage 500 ppm of total mogroside. A blend of mogrosides may reduce the licorice flavor of beverage as compared to Siamenoside I individually in a beverage.

A blend of mogrosides with 20 wt % of mogroside V or 10 wt % of mogroside IIIE is generally perceived as less astringent than siamenoside I alone in a beverage at 500 ppm of total mogroside. A blend of mogrosides can reduce the intensity of astringent mouthfeel as compared to Siamenoside I individually in a beverage.

1. A diet beverage comprising a mogroside blend in a sweetening amount, wherein the mogroside blend comprises at least about 70% siamenoside I by weight on a dry basis and at least one of the following:
a. from 0.01% to about 25% isomogroside V by weight on a dry basis;
b. from about 0.01% to about 25% 11-oxomogroside V by weight on a dry basis;
c. from about 0.01% to about 5% mogroside III by weight on a dry basis;
d. from about 0.01% to about 5% mogroside IIE by weight on a dry basis
e. from about 0.01% to about 30% mogroside V by weight on a dry basis; and
f. from about 0.01% to about 20% mogroside IIIE by weight on a dry basis.

2. The diet beverage of claim 1, wherein the mogroside blend comprises at least about 70% siamenoside I by weight on a dry basis and at least one of the following:
a. from 0.01% to about 25% isomogroside V by weight on a dry basis;
b. from about 0.01% to about 25% 11-oxomogroside V by weight on a dry basis;
c. from about 0.01% to about 5% 11-oxomogroside III by weight on a dry basis;
d. from about 0.01% to about 5% mogroside III by weight on a dry basis;
e. from about 0.01% to about 5% 11-oxoisomogroside V by weight on a dry basis;
f. from about 0.01% to about 5% mogroside IIE by weight on a dry basis;
g. from about 0.01% to about 10% mogroside IVA by weight on a dry basis;
h. from about 0.01% to about 20% mogroside IIIA2 by weight on a dry basis;
i. from about 0.01% to about 20% mogroside IIA by weight on a dry basis;
j. from about 0.01% to about 5% mogroside IIA1 by weight on a dry basis;
k. from about 0.01% to about 1% mogroside IA by weight on a dry basis;
l. from about 0.01% to about 1% mogroside IE by weight on a dry basis;
m. from about 0.01% to about 1% oxomogroside IIA1 by weight on a dry basis;
n. from about 0.01% to about 1% oxomogroside IIA2 by weight on a dry basis;
o. from about 0.01% to about 2.5% 11-oxomogroside IIA by weight on a dry basis;
p. from about 0.01% to about 20% 11-oxomogroside IIE by weight on a dry basis;
q. from about 0.01% to about 30% mogroside V by weight on a dry basis;
r. from about 0.01% to about 20% mogroside IIIE by weight on a dry basis;
s. from about 0.01% to about 20% 11-oxosiamenoside I by weight on a dry basis; and/or
t. from about 0.01% to about 20% 11-oxomogroside IIIE by weight on a dry basis.

3. The diet beverage of claim 1, wherein the mogroside blend is present in a concentration from about 10 ppm to about 600 ppm.

4. The diet beverage of claim 1, wherein the mogroside blend is present in a concentration from about 25 ppm to about 600 ppm.

5. The diet beverage of claim 1, wherein the mogroside blend is present in a concentration of from about 250 ppm to about 400 ppm.

6. The diet beverage of claim 1, wherein the mogroside blend is present in a concentration of from about 200 ppm to about 400 ppm.

7. The diet beverage of claim 1, wherein the mogroside blend is the sole sweetener in the beverage.

8. The diet beverage of claim 1, wherein the beverage comprises one or more additional sweeteners.

9. The diet beverage of claim 6, wherein the additional sweetener is selected from the group consisting of stevia, rebaudioside M, rebaudioside D, rebaudioside A, rebaudioside N, rebaudioside AM, rebaudioside O, rebaudioside E, steviolmonoside, steviolbioside, rubusoside, dulcoside B, dulcoside A, rebaudioside B, rebaudioside G, stevioside, rebaudioside C, rebaudioside F, rebaudioside I, rebaudioside H, rebaudioside L, rebaudioside K, rebaudioside J, rebaudioside M2, rebaudioside D2, rebaudioside S, rebaudioside T, rebaudioside U, rebaudioside V, rebaudioside W, rebaudioside Z1, rebaudioside Z2, rebaudioside IX, enzymatically glucosylated steviol glycosides, monatin and its salts (monatin SS, RR, RS, SR), curculin, glycyrrhizic acid and its salts, thaumatin (and variants thereof), monellin (and variants thereof), Amai protein (and variants thereof), sweet truffle protein (and variants thereof), mabinlin, brazzein (and variants thereof), hemandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, cyclocarioside I, sucralose, potassium acesulfame, aspartame, alitame, saccharin, neohesperidin dihydrochalcone synthetic derivatives, cyclamate, neotame, dulcin, suosan, advantame, sorbitol, mannitol, lactitol, maltitol, xylitol, erythritol, allulose, tagatose, cellobiose, 5-ketofructose and combinations thereof.

10. The diet beverage of claim 6, wherein the additional sweetener is a caloric sweetener selected from the group consisting of sucrose, glyceraldehyde, dihydroxyacetone, erythrose, threose, erythrulose, arabinose, lyxose, ribose, xylose, ribulose, xylulose, allose, altrose, galactose, glucose, gulose, idose, mannose, talose, fructose, allulose, sorbose, tagatose, mannoheptulose, sedoheltulose, octolose, fucose, rhamnose, arabinose, turanose, sialose, high fructose corn syrup, high fructose starch-based syrup, and combinations thereof.

11. The diet beverage of claim 10, wherein the caloric sweetener is selected from the group consisting of sucrose, high fructose corn syrup, high fructose starch-based syrups, fructose, glucose and combinations thereof.

12. The diet beverage of claim 8, wherein the caloric sweetener is present in an amount from about 1 wt % to about 10 wt %.

13. The diet beverage of claim 1, wherein the beverage is selected from a reduced-calorie beverage and a zero-calorie beverage.

14. The diet beverage of claim 1, wherein the beverage is carbonated.

15. The diet beverage of claim 1, wherein the beverage is non-carbonated.

16. The diet beverage of claim 1, wherein the beverage is an alcoholic beverage.

17. The diet beverage of claim 1, wherein the beverage has a sucrose equivalence from about 5% (w/v) to about 15% (w/v), from about 5% (w/v) to about 10% (w/v), or about 10% (w/v) or greater.

18. The diet beverage of claim 1 or claim 2, further comprising at least one organic acid salt selected from the group consisting of: sodium gluconate, sodium citrate, sodium lactate, potassium gluconate, potassium citrate, potassium lactate, calcium gluconate, calcium citrate, calcium lactate, calcium lactate gluconate, magnesium gluconate, magnesium citrate, magnesium lactate, magnesium lactate gluconate, and anhydrous and hydrate forms thereof.

19. A beverage concentrate or syrup comprising a mogroside blend in a sweetening amount when combined with a liquid matrix to produce a beverage, wherein the mogroside blend comprises at least about 70% siamenoside I by weight on a dry basis and at least one of the following:
a. from 0.01% to about 25% isomogroside V by weight on a dry basis;
b. from about 0.01% to about 25% 11-oxomogroside V by weight on a dry basis;
c. from about 0.01% to about 5% mogroside III by weight on a dry basis;
d. from about 0.01% to about 5% mogroside IIE by weight on a dry basis
e. from about 0.01% to about 30% mogroside V by weight on a dry basis; and
f. from about 0.01% to about 20% mogroside IIIE by weight on a dry basis.

20. The beverage concentrate or syrup of claim 19, wherein the mogroside blend comprises at least about 70% siamenoside I by weight on a dry basis and at least one of the following:
a. from 0.01% to about 25% isomogroside V by weight on a dry basis;
b. from about 0.01% to about 25% 11-oxomogroside V by weight on a dry basis;
c. from about 0.01% to about 5% 11-oxomogroside III by weight on a dry basis;
d. from about 0.01% to about 5% mogroside III by weight on a dry basis;
e. from about 0.01% to about 5% 11-oxoisomogroside V by weight on a dry basis;
f. from about 0.01% to about 5% mogroside IIE by weight on a dry basis;
g. from about 0.01% to about 10% mogroside IVA by weight on a dry basis;
h. from about 0.01% to about 20% mogroside IIIA2 by weight on a dry basis;
i. from about 0.01% to about 20% mogroside IIA by weight on a dry basis;
j. from about 0.01% to about 5% mogroside IIA1 by weight on a dry basis;
k. from about 0.01% to about 1% mogroside IA by weight on a dry basis;
l. from about 0.01% to about 1% mogroside IE by weight on a dry basis;
m. from about 0.01% to about 1% oxomogroside IIA1 by weight on a dry basis;
n. from about 0.01% to about 1% oxomogroside IIA2 by weight on a dry basis;
o. from about 0.01% to about 2.5% 11-oxomogroside IIA by weight on a dry basis;
p. from about 0.01% to about 20% 11-oxomogroside IIE by weight on a dry basis;
q. from about 0.01% to about 30% mogroside V by weight on a dry basis;
r. from about 0.01% to about 20% mogroside IIIE by weight on a dry basis;
s. from about 0.01% to about 20% 11-oxosiamenoside I by weight on a dry basis; and/or
t. from about 0.01% to about 20% 11-oxomogroside IIIE by weight on a dry basis.
